(19) United States
(12) Patent Application Publication
(10) Pub. No.: US 2025/0299600 A1
(43) Pub. Date: Sep. 25, 2025

(54) APPARATUS AND METHOD FOR OUTPUTTING INFORMATION

(71) Applicant: DOT INCORPORATION, Seoul (KR)

(72) Inventors: Ju Yoon KIM, Gimpo-si (KR); Ji Ho KIM, Gimpo-si (KR); Hyeon Cheol PARK, Gwangmyeong-si (KR)

(21) Appl. No.: 19/233,218

(22) Filed: Jun. 10, 2025

Related U.S. Application Data
(63) Continuation-in-part of application No. 19/002,676, filed on Dec. 26, 2024.
Application No. 19/002,676 is a continuation-in-part of application No. PCT/KR2023/018721, filed on Nov. 21, 2023.
(63) Continuation of application No. PCT/KR2023/018686, filed on Nov. 20, 2023.

(30) Foreign Application Priority Data
Dec. 21, 2022 (KR) 10-2022-0180933
Dec. 21, 2022 (KR) 10-2022-0180934
Jun. 23, 2023 (KR) 10-2023-0081213
Jun. 23, 2023 (KR) 10-2023-0081214

(51) Int. Cl. G09B 21/00; G06T 7/11; G06T 7/136; G06T 7/194

(52) U.S. Cl. CPC G09B 21/004; G06T 7/11; G06T 7/136; G06T 7/194

(57) ABSTRACT

An apparatus and a method for outputting information in which the apparatus includes a first information output portion including a first information output cell which is arranged in a grid structure and includes a preset number of first information output units configured to tactilely sense in an event of upward movement or downward movement in at least one direction, a second information output portion provided at a different location from the first information output portion and including a second information output cell which is arranged in a grid structure and includes a preset number of second information output units, and a processor for detecting one or more of an image and a text from content being input, generating a first driving signal driving the first information output unit according to a result of detecting the image, transmitting the first driving signal to the first information output portion, generating a second driving signal driving the second information output unit according to a result of detecting the text, and transmitting the second driving signal to the second information output portion.

### CROSS REFERENCE TO RELATED APPLICATIONS

This application is a Continuation-in-Part Application of U.S. patent application Ser. No. 19/002,676, filed on Dec. 26, 2024, which is a Continuation-in-Part Application of International Patent Application No. PCT/KR2023/018721, filed on Nov. 21, 2023, which claims priority from and the benefit of Korean Patent Application Nos. 10-2022-0180934, filed on Dec. 21, 2022 and 10-2023-0081214, filed on Jun. 23, 2023, each of which is hereby incorporated by reference for all purposes as if fully set forth herein. This application is also a Bypass Continuation of International Patent Application No. PCT/KR2023/018686, filed on Nov. 20, 2023, which claims priority from and the benefit of Korean Patent Application Nos. 10-2022-0180933, filed on Dec. 21, 2022 and 10-2023-0081213, filed on Jun. 23, 2023, each of which is hereby incorporated by reference for all purposes as if fully set forth herein.

### BACKGROUND

### FIELD

Embodiments of the invention relate generally to an information output apparatus and method, which output an image and text detected from content to be tactilely sensed, and to an interactive information processing device and method.

### DISCUSSION OF THE BACKGROUND

Users may recognize information in various ways. To this end, various types of information output apparatuses have been used. For example, visual information output apparatuses using printed materials, auditory information output apparatuses through sounds, tactile information output apparatuses through Braille, and the like have been used.

As tactile information output apparatuses through Braille deliver information by outputting only characters, information that may be recognized by visually impaired people is limited, and various types of content to be recognized may not be particularly identified.

Therefore, there is a need for an information output apparatus, which processes and outputs various types of content such as an image, text, a graph, a diagram, and an equation to enable visually impaired people to easily recognize various types of information.

Further, in the case of a tactile information output device using Braille, since the information that may be output is limited, an information processing device capable of processing various graphical information such as graphs, diagrams, equations, etc. and transmitting them to the information output device is required.

The above information disclosed in this Background section is only for understanding of the background of the inventive concepts, and, therefore, it may contain information that does not constitute prior art.

### SUMMARY

An information output apparatus and method according to embodiments of the invention enable particular information regarding various types of content to be easily recognized through tactile sensation by controlling first and second information output portions that may tactilely sense according to the result of detecting an image and a text from input content to display the image on the first information output portion and display the text on the second information output portion.

An information output apparatus and method according to embodiments of the invention enable a feature of a key subject (object) within an image to be intuitively recognized through tactile sensation by performing image processing (e.g., semantic rendering processing, binarized image generation) on the image detected from content and controlling a first information output portion on the basis of the result of performing the image processing to display the feature of the key subject within the image on the first information output portion.

An information output apparatus and method according to embodiments of the invention easily control a first information output unit formed to tactilely sense in the event of upward movement or downward movement to allow a key subject within an image to be output to a first information output portion by displaying a flag in at least one unit cell from among unit cells of a set size on the basis of the key subject within the image to generate a matching image for an output of the key subject and generating a driving signal for the first information output unit on the basis of the flag displayed in the matching image.

An information output apparatus and method according to embodiments of the invention enable a key subject of an image to be accurately displayed even in the case where the image within content is distorted or partially unclear by detecting, from a memory, a reference key subject corresponding to the key subject of the image detected from the content and controlling a first information output unit on the basis of the reference key subject.

An interactive information processing device and method according to embodiments of the invention are capable of processing graphical information and transmitting the processed graphical information to a tactile information output device so that the graphical information may be perceived through the tactile information output device.

An information output apparatus according to one or more embodiments of the invention includes a first information output portion including a first information output cell which is arranged in a grid structure and includes a preset number of first information output units configured to tactilely sense in an event of upward movement or downward movement in at least one direction, a second information output portion provided at a different location from the first information output portion and including a second information output cell which is arranged in a grid structure and includes a preset number of second information output units, and a processor configured to detect one or more of an image and a text from content being input, generate a first driving signal driving the first information output unit according to a result of detecting the image, transmit the first driving signal to the first information output portion, generate a second driving signal driving the second information output unit according to a result of detecting the text, and transmit the second driving signal to the second information output portion.

An information output method according to one or more embodiments of the invention is performed by a processor of an information output apparatus and includes detecting one or more of an image and a text from content being input, generating a first driving signal driving a first information output unit according to a result of detecting the image and transmitting the first driving signal to a first information output portion, and generating a second driving signal driving a second information output unit according to a result of detecting the text and transmitting the second driving signal to a second information output portion. The first information output portion includes a first information output cell arranged in a grid structure and including a preset number of first information output units configured to tactilely sense in an event of upward movement or downward movement in at least one direction, and the second information output portion is provided at a different location from the first information output portion and includes a second information output cell arranged in a grid structure and including a preset number of second information output units.

Additional features of the inventive concepts will be set forth in the description which follows, and in part will be apparent from the description, or may be learned by practice of the inventive concepts.

In addition, another method for implementing the inventive concepts, another system, and a computer-readable recording medium that stores a computer program for executing the method may be further provided.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a view schematically illustrating the appearance of an information output apparatus according to the inventive concepts.

FIG. 2 is a view illustrating operations of information output cells included in first and second information output portions of FIG. 1.

FIG. 3, FIG. 4, and FIG. 5 are views illustrating an operation of an information output unit included in an information output cell of FIG. 2.

FIG. 6 is a diagram schematically illustrating components of an information output apparatus according to the inventive concepts.

FIG. 7 and FIG. 8 are diagrams schematically illustrating components of first and second information output portions of FIG. 6.

FIG. 9 is a diagram illustrating an example of other components of an information output apparatus according to the inventive concepts.

FIG. 10 is a view illustrating another example of the appearance of an information output apparatus according to the inventive concepts.

FIG. 11 is a view illustrating an example of image processing in an information output apparatus according to the inventive concepts.

FIG. 12 is a view illustrating another example of image processing in an information output apparatus according to the inventive concepts.

FIG. 13 is a view illustrating another example of image processing in an information output apparatus according to the inventive concepts.

FIG. 14 is a flowchart illustrating an information output method according to the inventive concepts.

FIG. 15 is a flowchart illustrating an example of an image processing method in an information output apparatus, according to the inventive concepts.

FIG. 16 is a flowchart illustrating another example of an image processing method in an information output apparatus, according to the inventive concepts.

FIG. 17 is an illustration of an interactive information processing environment according to inventive concepts.

FIG. 18 is a schematic block diagram illustrating a configuration of an interactive information processing device according to the inventive concepts.

FIG. 19, FIG. 20, FIG. 21, FIG. 22, and FIG. 23 are illustrations of a user interface screen displayed on the interactive information processing device of FIG. 2.

FIG. 24, FIG. 25, and FIG. 26 are illustrations of an information output device included in the interactive information processing environment according to and the inventive concepts.

FIG. 27 is a flow diagram illustrating an interactive information processing method according to the inventive concepts.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The advantages and features of the inventive concepts, and methods of achieving them, will become apparent with reference to the embodiments described in detail in conjunction with the accompanying drawings. It should be understood, however, that the inventive concepts are not limited to the embodiments set forth below, but may be embodied in many different forms and includes all modifications, equivalents, or substitutions that are within the spirit and scope of the invention. The embodiments set forth below are provided to make the disclosure complete and to give those of ordinary skill in the art to which the disclosure belongs a complete idea of the scope of the invention. In describing the invention, detailed descriptions of related art will be omitted where it is believed that such descriptions would obscure the essence of the invention.

The terms used herein are intended to merely describe particular embodiments, but not to limit the inventive concepts. Expressions in the singular include the plural unless the context clearly indicates otherwise. It should be understood that as used herein, the terms “including” or “having” and the like are intended to designate the presence of the features, numbers, steps, actions, components, parts, or combinations thereof described herein, but not to preclude the possibility of the presence or addition of one or more other features, numbers, steps, actions, components, parts, or combinations thereof. Terms first, second, and the like may be used to describe various components, but the components are not to be limited by such terms. These terms are used solely for the purpose of distinguishing one component from another.

Further, as used herein, a “part” may be a hardware component, such as a processor or circuit, and/or a software component executed by a hardware component, such as a processor.

Embodiments according to the inventive concepts will now be described in detail with reference to the accompanying drawings, wherein identical or corresponding components are given the same reference signs and duplicate descriptions thereof will be omitted.

In the following embodiments, the terms first, second, etc. are not intended to be limiting, but are used to distinguish one component from another.

In the following embodiments, expressions of the singular include the plural unless the context clearly indicates otherwise.

In the following embodiments, terms including or having are intended to imply the presence of the features or components described, but not to preclude the possibility of the presence or addition of one or more other feature or components.

A particular sequence of processes may be performed in a different order than that described when an embodiment is otherwise practicable. For example, two processes described in succession may be performed substantially simultaneously, or may be performed in the opposite order from that described.

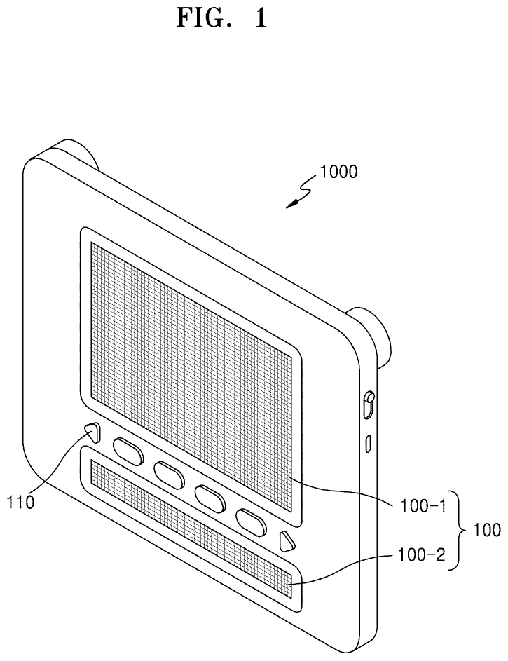

FIG. 1 is a view schematically illustrating the appearance of an information output apparatus according to the present embodiment.

Referring to FIG. 1, an information output apparatus 1000 may include an information output portions 100 and a plurality of user interfaces (UIs) 110. In the present embodiment, the information output portions 100 may include first information output portion 100-1 and second information output portion 100-2.

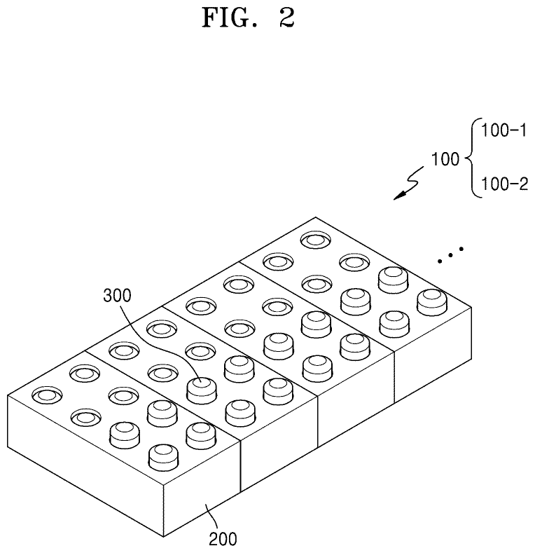

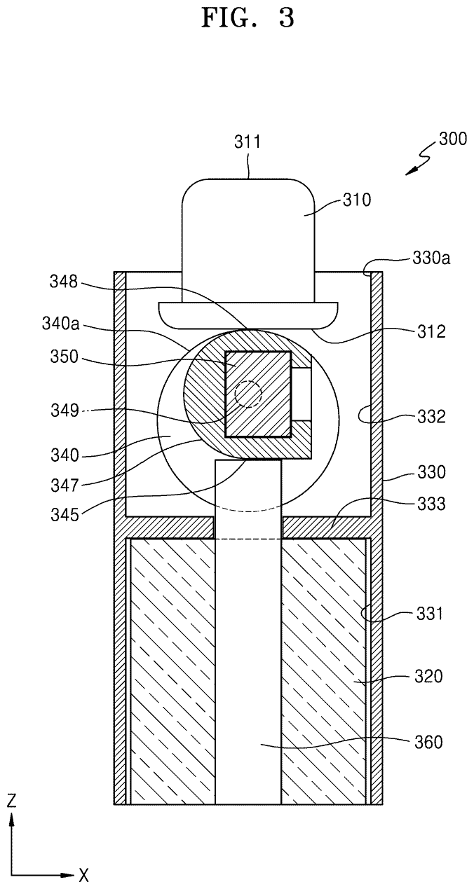

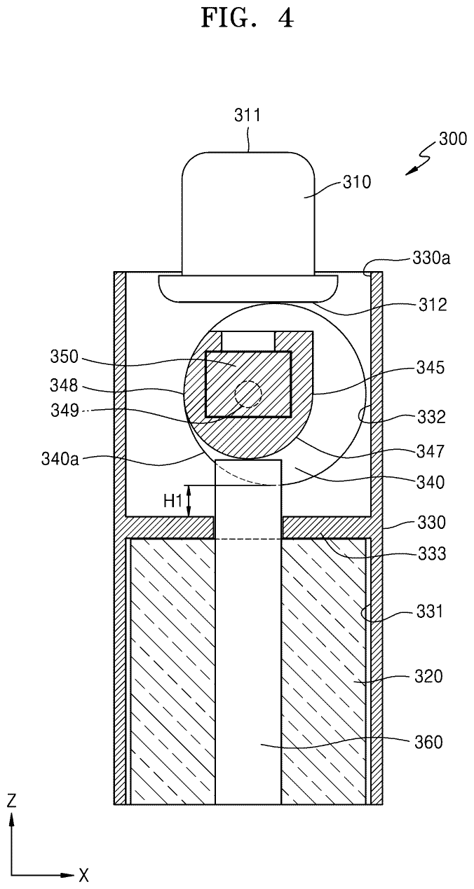

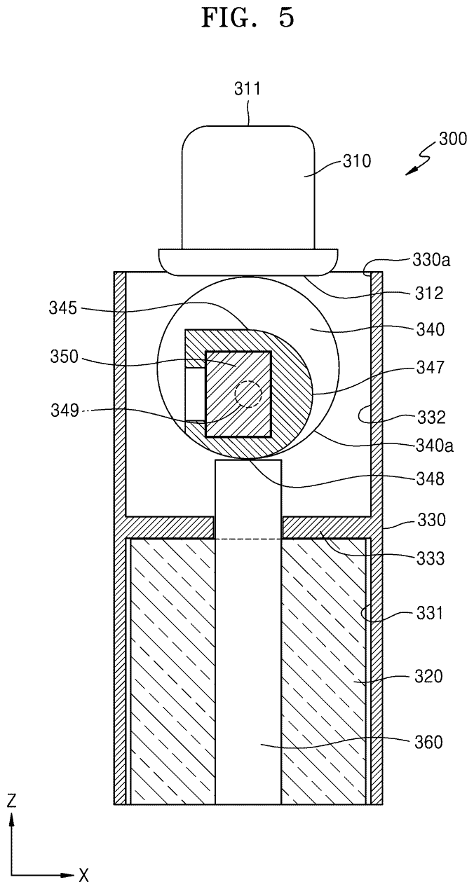

The first information output portion 100-1 and the second information output portion 100-2 may include a plurality of information output units 300 of FIGS. 2 and 3 and may output certain information (e.g., an image or text, or an image and text) in Braille form. For example, the first information output portion 100-1 may output an image in a Braille form, but is not limited thereto. In addition, the second information output portion 100-2 provided at a different location from the first information output portion 100-1 may output text in a Braille form, but is not limited thereto.

In the present embodiment, a size of the first information output portion 100-1 is configured to be greater than a size of the second information output portion 100-2 and thus facilitates an output of an image having a relatively greater size than text.

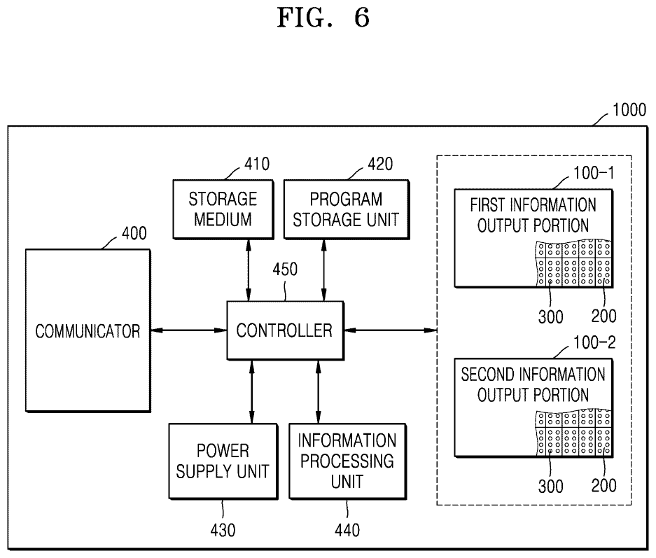

The plurality of user interfaces 110 may include a manipulation portion that manipulates the information output apparatus 1000. The manipulation portion may be configured in a sensor, button, or switch structure capable of recognizing a touch or press manipulation by a user. In the present embodiment, the manipulation portion may transmit, to a controller 450 of FIG. 6, a manipulation signal manipulated by the user to check or change various types of information related to driving of the information output units 300 included in the first and second information output portions 100-1 and 100-2.

FIG. 2 is a view illustrating operations of information output cells included in first and second information output portions of FIG. 1. In the following description, the description of the same portion as the description of FIG. 1 is omitted.

Referring to FIG. 2, each of first and second information output portions 100-1 and 100-2 may include a plurality of information output cells 200 (200_1 to 200_N). Here, the first and second information output portions 100-1 and 100-2 have different sizes and may include different numbers of information output cells. For example, the size of the first information output portion 100-1 may be formed to be greater than the size of the second information output portion 100-2. Accordingly, the number of information output cells within the first information output portion 100-1 may be greater than the number of information output cells within the second information output portion 100-2. As an embodiment, the first information output portion 100-1 may include a total of 300 information output cells 200 corresponding to 30×10, and the second information output portion 100-2 may include a total of 100 information output cells 200 corresponding to 10×10, but are not limited thereto and each may include more information output cells 200 than the same.

Braille information that is output to the first and second information output portions 100-1 and 100-2 may be output in units of the information output cells 200 including the information output units 300 arranged in four rows and two columns, and when applied to the present embodiment, the information output cell 200 may include eight information output units 300.

In the present embodiment, one information output cell 200 is limited as including eight information output units 300, but is not limited thereto, one information output cell 200 may include two to eight information output units 300, and in some cases, may include more information output units 300.

FIGS. 3 to 5 are views illustrating an operation of an information output unit included in an information output cell of FIG. 2. In the following description, the description of the same portion as the description of FIGS. 1 and 2 is omitted. Referring to FIGS. 3 to 5, the first and second information output portions 100-1 and 100-2 of the present embodiment may include at least one information output cell 200, and the information output cell 200 may include a plurality of information output units 300 (e.g., eight in four rows and two columns).

The information output unit 300 may include a coil portion 320, a base portion 330, a driving portion 340, and an expression member 310.

The expression member 310 may move according to movement of the driving portion 340 described below, and may move a location upwards and downwards at least on the basis of a longitudinal direction of the expression member 310. For example, the expression member 310 may move in one direction towards the coil portion 320 and in a direction opposite thereto.

Accordingly, the expression member 310 may move to protrude in one direction, and a user may tactilely or visually sense the movement of the expression member 310.

The representation member 310 may include an expression surface 311 and a support surface 312.

The support surface 312 may be a surface facing the driving portion 340 from among areas of the expression member 310, form a lower area of the expression member 310, and contact the driving portion 340, and the driving portion 340 may transmit a force to the expression member 310 through the support surface 312. For example, a driving surface 340a of the driving portion 340 may be in contact with the support surface 312 and move the support surface 312 in a first direction, i.e., in a Z-axis direction on the basis of FIG. 5.

The expression surface 311 is an outermost area, e.g., a farthest area from the coil portion 320, from among the areas of the expression member 310 and may include an area recognized by the user.

For example, the user may recognize the entire area of the expression member 310, but may recognize only the expression surface 311. For example, the user may sense the movement of the expression member 310 through the contact of the expression surface 311, and the user may also easily sense the movement of the expression member 310 through visual sensing of the expression surface 311.

As an optional embodiment, the expression surface 311 may include a curved surface.

The expression member 310 may have various shapes, and may include a pillar-shaped area, e.g., may include an area having a shape similar to a cylinder.

In addition, as an optional embodiment, a protruding area of the expression member 310 may have a curved surface, and corners may have curved surfaces.

The expression member 310 may include various materials, and may be formed of an insulating material as a light and durable material. For example, the expression member 310 may include a resin-based organic material. As another example, the expression member 310 may include an inorganic material such as a ceramic material.

In addition, as another selective embodiment, the expression member 310 may also be formed of a material such as metal or glass.

The coil portion 320 may be formed to be connected to an external power source (not shown). When a current flows through the coil portion 320, a magnetic field may be formed around the coil portion 320.

The coil portion 320 may have various shapes, e.g., the coil portion 320 may have a shape in which electric wires are wound a plurality of times, and the number of times being wound or the like may be variously controlled.

The driving portion 340 may move through the magnetic field generated by the current flowing through the coil portion 320, and a driving force of the movement of the expression member 310 may be provided through the movement of the driving portion 340 described above.

As an optional embodiment, a support portion 360 may be further arranged, and at least one area of the support unit 360 may be arranged to be adjacent to or support the coil portion 320.

For example, the support portion 360 may include an elongated area and may be arranged to pass through the coil portion 320, and as a particular example, a plurality of coils of the coil portion 320 may be wound around the support portion 360.

As an optional embodiment, one end of the support portion 360 may be elongated to support the driving portion 340 described below, and the movement of the driving portion 340 may be performed while being supported by the one end of the support portion 360.

As an optional embodiment, the support portion 360 may be formed to correspond to a through hole portion (not shown) of the base portion 330.

As an optional embodiment, the support portion 360 may include a magnetic substance, and as a particular example, an extension member (not shown) may contain a magnetic substance. Accordingly, when the magnetic field is generated through the coil portion 320, a magnitude of the magnetic field may increase, and power consumption of the information output portion 100 may be reduced by efficiently generating the magnetic field.

The base portion 330 may be formed to accommodate the coil portion 320. For example, the base portion 330 may include a first accommodation portion 331 and a second accommodation portion 332.

The first accommodation portion 331 and the second accommodation portion 332 may be arranged adjacent to each other or may be arranged not to overlap each other.

As an optional embodiment, the first accommodation portion 331 and the second accommodation portion 332 may be spaced apart from each other.

As another selective embodiment, the first accommodation portion 331 and the second accommodation portion 332 may be connected to each other via a through hole.

The coil portion 320 may be arranged in the first accommodation portion 331. As an optional embodiment, the support portion 360 described above may be arranged in the first accommodation portion 331, and one area of the support portion 360 may be extended and arranged even into the second accommodation portion 332 through the through hole.

Although not illustrated, as an optional embodiment, a driving groove (not shown) may be formed in the second accommodation portion 332 of the base portion 330. For example, the driving groove (not shown) may be formed in both sides of an internal surface of the second accommodation portion 332 of the base portion 330, which face each other, and as an optional embodiment, may have a shape extending in one direction, e.g., in a direction away from the coil portion 320.

The base portion 330 may have a shape elongated to accommodate the coil portion 320 and the driving portion 340, and may be formed to entirely surround both the coil portion 320 and the driving portion 340.

As an optional embodiment, the base portion 330 may include a boundary portion 333 between the first accommodation portion 331 and the second accommodation portion 332.

The first accommodation portion 331 and the second accommodation portion 332 may be separated from each other through the boundary portion 333.

As an optional embodiment, the through hole may be formed in the boundary portion 333 and may be arranged so that one area of the support portion 360 may extend and pass through the through hole.

In addition, the base portion 330 may include an inlet portion 330a, and the inlet portion 330a may be connected to the second accommodation portion 332. Through the inlet portion 330a, the expression member 310 may move so that a length thereof protruding to the outside of the base portion 330 changes.

The driving portion 340 may be arranged in the base portion 330. The driving portion 340 may be arranged in the second accommodation portion 332 and may be spaced apart from the coil portion 320 arranged in the first accommodation portion 331.

The driving portion 340 may be arranged adjacent to the coil portion 320 and may be driven by the current flowing through the coil portion 320 to perform angular movement or rotational movement. Through the driving portion 340, the expression member 310 may perform upward movement and downward movement, e.g., in one direction towards the coil portion 320 and in the direction opposite thereto.

As an optional embodiment, a magnetic force portion 350 may be arranged in the driving unit 340, e.g., in an internal space. For example, the magnetic force portion 350 may contain a magnetic force material, e.g., may include a permanent magnet.

The magnetic force portion 350 may have a first area (e.g., an N pole or an S pole) and a second area (e.g., an S pole or an N pole) having different polarities, and the first area and the second area having different polarities may be arranged in a direction from the coil portion 320 towards the expression member 310 at one point during rotation of the driving portion 340, e.g., in the Z-axis direction.

For example, on the basis of FIG. 5, the first area and the second area of the magnetic force portion 350 having different polarities may be arranged in the direction from the coil portion 320 towards the expression member 310, e.g., in the Z-axis direction.

The driving portion 340 includes the driving surface 340a at least on an outer surface thereof, and the driving surface 340a may be formed to support the expression member 310 and may provide a driving force for the upward movement and the downward movement of the expression member 310.

As an optional embodiment, the driving surface 340a of the driving portion 340 may be an outer surface and include a curved surface. As a more particular embodiment, the driving surface 340a of the driving portion 340 may include a boundary line having a shape similar to a circle.

The driving portion 340 may include a driving controller 349.

A driving location of the driving portion 340 may be controlled through the driving controller 349. For example, when the driving unit 340 moves by the coil unit 320, the driving portion 340 may perform angular movement or rotational movement on the basis of the driving controller 349.

As an optional embodiment, a central axis of the driving portion 340 and the driving controller 349 may not match each other and may be eccentric.

In addition, as an optional embodiment, the magnetic force portion 350 may not match the central axis of the driving portion 340, e.g., may be arranged to overlap one area of the driving controller 349.

Accordingly, torque with respect to the driving portion 340 may be easily generated, and the driving portion 340 may be allowed to perform angular movement or rotational movement, and thus, the movement of the expression member 310 may be efficiently performed and precise expression power of the information output portion 100 may be improved. Also, power consumption of the information output portion 100 may be reduced.

Although not illustrated, the driving portion 340 may include a first driving member (not shown) and a second driving member (not shown), and may include a spaced space (not shown) therebetween.

At least one surface of outer surfaces of the first driving member (not shown) and the second driving member (not shown) may include the driving surface 340a to support the expression member 310 when the driving portion 340 moves and thus provide a driving force to the expression member 310. For example, an outer boundary line (e.g., a circle) of the driving portion 340 including the driving surface 340a illustrated in FIG. 5 may be a boundary line of the first driving member (not shown) or the second driving member (not shown).

The outer surfaces of the selective first driving member (not shown) and second driving member (not shown) may include a curved surface, e.g., the driving surface 340a may include a curved surface.

For example, the first driving member (not shown) and the second driving member (not shown) may have a similar shape to a rotating body or may each have a similar shape to a disk.

Accordingly, in the event of rotational or angular movement of the first driving member (not shown) and the second driving member (not shown), a natural driving force may be provided to the support surface 312 of the expression member 310 to allow the expression member 310 to efficiently perform continuous and natural movement.

The driving controller 349 may be arranged on at least one side surface of the driving portion 340, e.g., both side surfaces.

As an optional embodiment, the driving controller 349 may have a protruding shape, i.e., may protrude in a direction away from the side surface of the driving portion 340 (in a direction protruding in the drawing on the basis of FIG. 5), and as an optional embodiment, the protruding shape of the driving controller 349 may correspond to the driving groove (not shown) when the base unit 330 includes the driving groove.

For example, the driving portion 340 may move by the magnetic field by the coil unit 320, and as a particular example, may perform upward movement and downward movement due to a repulsive force and an attractive force acting on the magnetic force portion 350 within the driving portion 340. Here, the driving portion 340 may perform upward movement and downward movement while performing the rotational movement around the driving controller 349.

As an optional embodiment, the driving portion 340 may move while the driving controller 349 of the driving portion 340 is arranged in one area of the base portion 330, e.g., in the driving groove (not shown) of the second accommodation portion 332.

A first movement area 345 and a second movement area 348 may be arranged in the spaced space between the first driving member (not shown) and the second driving member (not shown).

The first movement area 345 and the second movement area 348 may be areas that are respectively bases of the lowest point and the highest point in the event of movement of the driving portion 340.

As an optional embodiment, a connection area 347 may be arranged between the first movement area 345 and the second movement area 348, and the connection area 347 may include a curved surface.

For example, as shown in FIG. 5, when the first movement area 345 is arranged at the lowermost portion, i.e., in an area closest to the coil portion 320, the driving portion 340 is placed at the lowest point, and accordingly, the expression member 310 may also be at the lowest point, in detail, a height of the expression member 310 protruding from the base portion 330 may be the smallest. Here, the first movement area 345 may be supported by an upper end of the support portion 360.

Subsequently, as illustrated in FIG. 4, in the case where a current is applied to the coil portion 320 and thus a magnetic field is formed, the driving portion 340 may move, e.g., in the case where a repulsive force acts on the magnetic force portion 350 arranged in the driving portion 340, one end portion of the magnetic force portion 350 (a polar side on which the repulsive force acts) may be arranged to be away from a direction of the magnetic field and thus the connection area 347 may be supported by the upper end of the support portion 360. Referring to FIG. 4, the driving portion 340 rises, i.e., an uppermost surface of the driving portion 340 rises, and accordingly, the expression member 310 may also slightly rise and referring to FIG. 4, may rise by a height of H1.

As an optional embodiment, the driving portion 340 performs rotational movement on the basis of the driving controller 349, and thus, the driving controller 349 may maintain a location.

Subsequently, as illustrated in FIG. 5, in the case where a current is applied to the coil portion 320 of FIG. 4 and thus a magnetic field is maintained formed, the driving portion 340 may continuously move, e.g., from among an area of the magnetic force portion 350 arranged in the driving portion 340, one end portion of the magnetic force portion 350 on which an attractive force acts according to the generated magnetic field may be arranged close to the coil portion 320, and thus, the second movement area 348 may be supported by the upper end of the support unit 360. Referring to FIG. 5, the driving portion 340 rises, i.e., the uppermost surface of the driving portion 340 rises, and accordingly, the expression member 310 may also rise, and the state of FIG. 5 may be an uppermost rise point of the expression member 310.

As an optional embodiment, the driving portion 340 performs the rotational movement on the basis of the driving controller 349, and thus, the driving controller 349 may maintain the location.

As an optional embodiment, movement from the state of FIG. 4 to the state of FIG. 5 may be continuous. The state of FIG. 4 is to describe one process, and when the state of FIG. 5 is changed to the state of FIG. 4, the driving portion 340 and the expression member 310 may continuously move in the state of FIG. 4 without stopping and change to the state of FIG. 5.

For example, FIG. 3 and FIG. 5 illustrate that the expression member 310 may maintain stopping, and FIG. 4 may illustrate that the expression member 310 is during movement.

As an optional embodiment, a sequential movement process of FIGS. 5 may also be applied to an embodiment described below.

In the event of the rotational movement of the driving portion 340, the support portion 360 may support at least one area of the connection area 347 before supporting the first movement area 345 and then supporting the second movement area 348, and accordingly, the driving portion 340 may naturally move and thus may also precisely control the movement of the expression member 310.

A distance between the driving surface 340a and the first movement area 345 may be different from a distance between the driving surface 340a and the second movement area 348. For example, the distance between the driving surface 340a and the first movement area 345 may be greater than the distance between the driving surface 340a and the second movement area 348.

As an optional embodiment, a distance from a central axis of a shape of the

driving portion 340 to the first movement area 345 may be less than a distance from the central axis of the shape of the driving portion 340 to the second movement area 348.

As an optional embodiment, a distance from the driving controller 349 to the first movement area 345 may be the same as or similar to a distance from the driving controller 349 to the second movement area 348, and as an additional selective embodiment, may also be the same as or similar to a distance from the driving controller 349 to the connection area 347.

For example, the connection area 347 may correspond to at least one area of a circumference having a radius around of a central point of the driving controller 349, and the first movement area 345 and the second movement area 348 may respectively have flat surface shapes extending parallel to each other in areas that face each other and correspond to a diameter.

Accordingly, in the case where the support portion 360 supports the first movement area 345, the second movement area 348, and the connection are 347 when the driving portion 340 performs the rotational movement around the driving controller 349, the location of the driving controller 349 may be maintained the same or similar.

In addition, when supported by the support portion 360, the connection area 347 supported by the support portion 360 may include a surface close to a curved surface or an arc to enable smooth and soft movement of the driving portion 340 to be efficiently performed.

Although not illustrated, the second accommodation portion 332 of the base portion 330 may include a groove having at least a greater shape than the driving controller 349 to accommodate the driving controller 349.

The above description describes the case where the first movement area 345, the second movement area 348, and the connection area 347 are arranged in an area including the driving surface 340a of the driving portion 340, e.g., in the spaced space between the first driving member (not shown) and the second driving member (not shown). Also, the above description also applied to embodiments described below.

As another selective embodiment, the first movement area 345, the second movement area 348, and the connection area 347 may be arranged in the area including the driving surface 340a of the driving portion 340, e.g., on the outer surface of the first driving member (not shown) or the second driving member (not shown).

In addition, as another selective embodiment, the second movement area 348, and the connection area 347 may also be arranged in the area including the driving surface 340a of the driving unit 340, e.g., on both side surfaces of one of the first driving member (not shown) or the second driving member (not shown), and accordingly, the driving controller 349 may be arranged in an area including the first movement area 345, the second movement area 348, and the connection area 347.

In addition, various selective embodiments described above may include the case where a structure having the first movement area 345, the second movement area 348, and the connection area 347 in the area including the driving surface 340a, e.g., on an outer surface of a shape having a smaller size than the first driving member (not shown) or the second driving member (not shown), include variously modified structures.

In the present embodiment, the driving portion 340 of the information output unit 300 may move in at least a first direction or in a direction opposite thereto, and the expression member 310 may also move in the first direction or in the direction opposite thereto according to the movement of the driving portion 340 to output various types of information that may be sensed by the user.

For example, the information output unit 300 of the present embodiment may be a unit for outputting information according to the user sensing a surface of the expression member 310 through tactile sensation when the expression member 310 protrudes. More particularly, the output of the information may be, for example, information output in the form of a Braille output.

As an optional embodiment, the information output unit 300 may be a visual sensing type information output unit according to the user visually sensing the same when the expression member 310 protrudes. In particular, here, in the case where a color is formed on one surface of the expression member 310, e.g., on an upper surface, or is formed to generate light on one surface of the expression member 310, a visual effect may be increased.

Accordingly, the information output unit 300 of the present embodiment may output information to the user.

In addition, in detail, the driving portion 340 may easily move in the first direction, e.g., rise, by the magnetic field by the coil portion 320, and may move by performing the rotational movement while maintaining a certain area by the driving controller 349.

For example, in the case where a repulsive force is generated by the magnetic field generated by the coil portion 320 according to a polarity of the magnetic force portion 350 arranged inside the driving portion 340, the driving portion 340 may perform rising movement while performing rotational movement.

Accordingly, rise and fall of the driving portion 340 enable smooth, natural, and precise movement, and accordingly, reduce irregular intermittence of rise and fall of the expression member 310 and facilitate control of flexible movement and precise movement.

The expression member 310 may easily implement an on or off state of the information output apparatus 1000 by performing the rise and fall.

In addition, even in the case where a force applied to the driving portion 340 is removed through support, e.g., support for the first movement area 345 and the second movement area 348 by the support portion 360, during rise and fall operations of the driving portion 340, the state thereof may be maintained.

In other words, after rising from a stat in which the first movement area 345 is supported by an extension portion of the driving portion 340 to a state in which the second movement area 348 is supported by the extension portion, due to the magnetic field by the coil portion 320, the driving portion 340 may maintain the state in which the second movement area 348 supported by the extension portion even in the case where a power source connected to the coil portion 320 is removed or a current or voltage is removed.

In addition, after falling from the state in which the second movement area 348 is supported by the extension portion to the state in which the first movement area 345 is supported by the extension portion, due to a magnetic field through the coil portion 320 in an opposite direction, the driving portion 340 may maintain the state in which the first movement area 345 is supported by the extension portion even in the case where the power source connected to the coil portion 320 is removed or the current or voltage is removed.

Accordingly, on and off states of the expression member 310 of the information output unit 300 may be easily switched and maintained, power consumption for movement of the expression member 310 may be reduced, and the entire energy efficiency of the information output apparatus 1000 may be improved.

In addition, the driving controller 349 provided in the driving portion 340 of the present embodiment may be eccentric with the central axis of the driving portion 340, and accordingly, torque may be easily generated in the driving portion 340 to implement the rise and fall through the rotational movement of the driving portion 340 and thus control precise, smooth, and natural movement of the expression member 310.

As an optional embodiment, the magnetic force portion 350 provided in the driving portion 340 may be arranged to overlap the driving controller 349, e.g., a center of the magnetic force portion 350 and the driving controller 349 may overlap each other.

Accordingly, a change in a location of the magnetic force portion 350 may be reduced when the driving portion 340 rotates on the basis of the driving controller 349, e.g., a gap between the coil portion 320 and the magnetic force portion 350 may be maintained the same or similar. As a result, unevenness of an effect of the magnetic field through the coil unit 320 on the magnetic force portion 350 may be reduced, and precise control of the movement of the driving portion 340 may be facilitated.

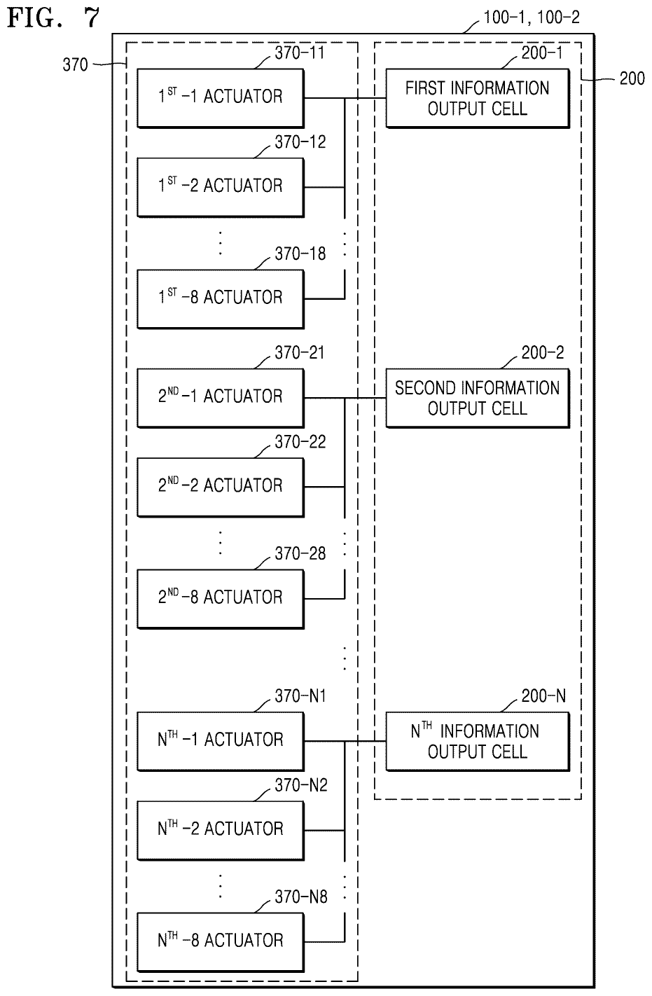

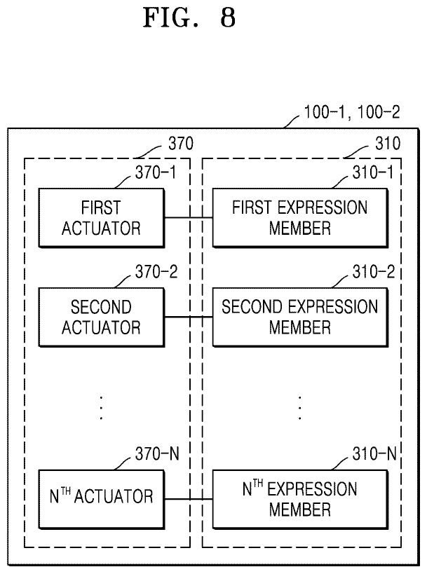

In the present embodiment, the coil portion 320, the base portion 330, the driving portion 340, the magnetic force portion 350, and the support portion 360 excluding the expression member 310 from among the information output unit 300 may be referred to as an actuator 370 of FIGS. 7 and 8.

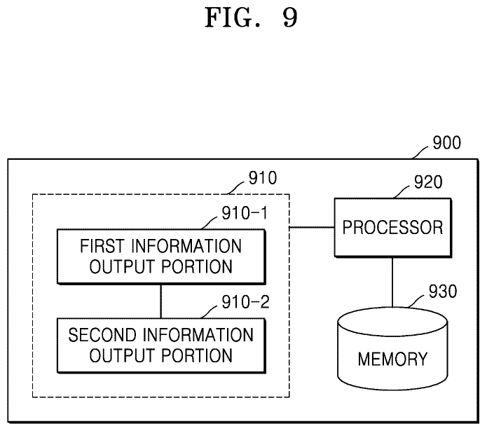

The actuator 370 may move and protrude or depress the expression member 310 in at least one direction by a driving signal generated by a processor 920 of FIG. 9 described below. Here, the driving signal may be in the form of a pulse wave, a driving signal in the form of a + pulse wave may be transmitted to the actuator 370 to move the expression member 310 upwards, and a driving signal in the form of a − pulse wave may be transmitted to the actuator 370 to move the expression member 310 downwards.

In the present embodiment, Braille information that is output to the first and second information output portions 100-1 and 100-2 may be driven in units of the information output cells 200. Driving signals may be simultaneously transmitted to eight actuators 370 that respectively drive eight information output units 300 to enable the information output cell 200 to output the Braille information.

FIG. 6 is a diagram schematically illustrating components of an information output apparatus according to the present embodiment, and FIGS. 7 and 8 are diagrams schematically illustrating components of first and second information output portions of FIG. 6. In the following description, the description of the same portion as the description of FIGS. 1 to 5 is omitted.

Referring to FIGS. 6 to 8, an information output apparatus 1000 may include first and second information output portions 100-1 and 100-2 including information output cells 200 and information output units 300, a communicator 400, a storage medium 410, a program storage unit 420, a power supply unit 430, an information processing unit 440, and a controller 450.

In addition, in the present embodiment, a “portion” may be a hardware component such as a processor or a circuit, and/or a software component executed by a hardware component such as a processor.

The information output portion 100 may drive the information output unit 300 included in the information output cell 200 to perform upward movement or downward movement on the basis of a driving signal according to a scheduling plan transmitted from the information processing unit 440 to enable a user to sense the same by tactile sensation.

FIG. 7 is a diagram schematically illustrating components of a first or second information output portion 100-1 or 100-2, according to an embodiment and illustrates an example of driving, in units of information output cells 200, Braille information that is to be output to the first information output portion 100-1 and the second information output portion 100-2.

Referring to FIG. 7, the information output portion 100 may include N information output cells 200, and each information output cell may include eight actuators 370. The inventive concepts are not limited thereto, and each information output cell may include six actuators 370. Alternatively, each information output cell may include four actuators 370.

From FIG. 7, in the case where a 1^{st}-1 actuator 370-11 to a 1^{st}-8 actuator 370-18 are connected to a first information output cell 200-1 and in the case where the first information output cell 200-1 is to be driven, eight driving signals may be simultaneously applied to the 1^{st}-1 actuator 370-11 to the 1^{st}-8 actuator 370-18, respectively. Here, the eight driving signals may be one of a + pulse voltage and a − pulse voltage.

From FIG. 7, in the case where a 2^{nd}-1 actuator 370-21 to a 2^{nd}-8 actuator 370-28 are connected to s second information output cell 200-2 and in the case where the second information output cell 200-2 is to be driven, eight driving signals may be simultaneously applied to the 2^{nd}-1 actuator 370-21 to the 2^{nd}-8 actuator 370-28, respectively. Here, the eight driving signals may be one of a + pulse voltage and a − pulse voltage.

FIG. 8 is a diagram schematically illustrating components of a first or second information output portion 100-1 or 100-2, according to another embodiment. FIG. 8 illustrates an example of driving, in units of information output units 300, Braille information that is to be output to the first information output portion 100-1 and the second information output portion 100-2.

From FIG. 8, the first information output portion 100-1 and the second information output portion 100-2 may include N expression members 310 and N actuators 370.

From FIG. 8, a first actuator 370-1 may be connected to a first expression member 310-1, a second actuator 370-2 may be connected to a second expression member 310-2, and an N^{th} actuator 370-N may be connected to an N^{th} expression member 310-N.

Accordingly, in the case where the first expression member 310-1 is allowed to perform upward movement or downward movement, a driving signal may be applied to the first actuator 370-1, in the case where the second expression member 310-2 is allowed to perform upward movement or downward movement, a driving signal may be applied to the second actuator 370-2, and in the case where the N^{th} expression member 310-N is allowed to perform upward movement or downward movement, a driving signal may be applied to the N^{th} actuator 370-N.

Returning to FIG. 6, the communicator 400 may be provided to be linked to a network (not shown) and transmit a signal between an external apparatus (e.g., an information provision system, a server, or another information output apparatus (not shown)) and the information output apparatus 1000, and may provide a communication interface needed to provide the transmitted and received signal in the form of packet data. In addition, the communicator 400 may serve to receive a certain information request signal from the information output apparatus 1000, and may serve to transmit information processed by the information output apparatus 1000 to the outside. Here, the network is a medium that serves to connect the external apparatus and the information output apparatus 1000, and may include a path that provides a connection path so that the information output apparatus 1000 may connect to the external apparatus and then transmit and receive data.

In the present embodiment, the network may include wired networks such as local area networks (LANs), wide area networks (WANs), metropolitan area networks (MANs), and integrated service digital networks (ISDNs), or wireless networks such as wireless LANs, CDMA, Bluetooth, and satellite communication, but the scope of the inventive concepts are not limited thereto. In addition, the network may transmit and receive information by using short-range communication and/or long-range communication. Here, the short-range communication may include Bluetooth, radio frequency identification (RFID), infrared data association (IrDA), ultra-wideband (UWB), ZigBee, and wireless fidelity (Wi-Fi) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA) technologies.

The network may include connections of network elements such as a hub, a bridge, a router, and a switch. The network may include one or more connected networks including a public network such as the Internet and a private network such as a secure corporate private network, e.g., a multi-network environment. Access to the network may be provided via one or more wired or wireless access networks. In addition, the network may support Internet of Things (IoT) networks and/or 5G communication that exchange and process information between distributed components such as objects.

The storage medium 410 may perform a function of temporarily or permanently storing information processed by the controller 450 and/or information received from the outside through the communicator 400. Here, the storage medium 410 may include magnetic storage media or flash storage media, but the scope of the inventive concepts are not limited thereto. The storage medium 410 may include an internal memory and/or an external memory, and may include a volatile memory such as DRAM, SRAM, or SDRAM, a nonvolatile memory such as one time programmable ROM (OTPROM), PROM, EPROM, EEPROM, mask ROM, flash ROM, NAND flash memory, or NOR flash memory, a flash drive such as an SSD, a compact flash (CF) card, an SD card, a Micro-SD card, a Mini-SD card, an Xd card, or a memory stick, or a storage device such as an HDD.

The program storage unit 420 may include control software that performs a task of detecting one or more of an image and a text from content being input, a task of generating a first driving signal for driving the first information output portion 100-1 according to the result of detecting the image and transmitting the first driving signal to the first information output portion 100-1, a task of generating a second driving signal for driving the second information output portion 100-2 according to the result of detecting the text and transmitting the second driving signal to the second information output portion 100-2, and the like.

In addition, the program storage unit 420 may include control software that performs a task of selecting a plurality of information output cells to be driven according to information to be output to the first and second information output portions 100-1 and 100-2, a task of generating a scheduling plan designating a driving order for the plurality of selected information output cells, a task of generating a driving signal according to the scheduling plan and transmitting the driving signal to the information output cells, a task of determining a power operation mode of the information output apparatus 1000, a task of determining an information output mode according to a type of information to be output to the first and second information output portions 100-1 and 100-2, a task of converting information regarding the information output mode into Braille information and outputting the result of converting into the Braille information, a task of selecting a plurality of information output units to be driven according to information to be output to the first and second information output portions 100-1 and 100-2, a task of generating a scheduling plan designating a driving order for the plurality of selected information output units, a task of generating a driving signal according to the scheduling plan and transmitting the driving signal to the information output units, and the like.

The power supply unit 430 may, under control of the controller 450, receive external power and internal power and supply power to respective components of the information output apparatus 1000. The power supply unit 430 may operate in a first power mode that operates the information output apparatus 1000 by alternating current power. Also, the power supply unit 430 may operate in a second power mode that operates the information output apparatus 1000 by direct current power from a battery.

Here, the battery may be configured as an internal battery or a replaceable battery. The battery may be charged by a wired or wireless charging method, and the wireless charging method may include a magnetic induction method or a magnetic resonance method. In the present embodiment, the battery may include a rechargeable secondary battery such as a nickel-cadmium battery, a lead-acid battery, a nickel metal hydride (NiMH) battery, a lithium-ion battery, or a lithium polymer battery, but is not limited thereto.

The information processing unit 440 may process information received from the outside through the communicator 400, information stored in the storage medium 410, and/or self-generated information (e.g., text message information created on the information output apparatus 1000) to be output to the first and second information output portions 100-1 and 100-2. In the present embodiment, information may include content and/or Braille information, and the content may include a still image such as a photo, a cartoon, and a picture, a moving image, and a series of text.

The information processing unit 440 may detect one or more of an image and a text from content being input, generate a first driving signal for driving the first information output portion 100-1 according to the result of the detecting the image, and transmit the driving signal to the first information output portion 100-1. The information processing unit 440 may generate a second driving signal for driving the second information output portion 100-2 according to the result of detecting the text and transmit the driving signal to the second information output portion 100-2.

In addition, the information processing unit 440 may determine a power operation mode of the information output apparatus 1000 and on the basis of the power operation mode, generate a scheduling plan that designates a driving order of two or more Braille cells that may be simultaneously driven, from among a plurality of cells selected by a selector.

The information processing unit 440 may determine an information output mode according to a type of information to be output to the information output portion 100, convert information regarding the information output mode into Braille information, and output the result of converting into the Braille information. The information processing unit 440 may select, with respect to the result of converting text information into Braille, a first cell group corresponding to a plurality of cells to be driven as an active area and a second cell group corresponding to a plurality of cells to be driven as an inactive area. The information processing unit 440 may generate a scheduling plan to sequentially and primarily drive respective cells within the first cell group and sequentially and secondarily drive respective cells within the second cell group as the primary driving is completed.

The information processing unit 440 described above generates driving signals in units of information output cells 200 and transmits the driving signals to the information output cells 200, but as another embodiment, the information processing unit 440 may generate driving signals in units of information output units 300 and transmit the driving signals to the information output units 300. To this end, the information processing unit 440 may select a plurality of information output units 300 to be driven according to information to be output to the first and second information output portions 100-1 and 100-2. The information processing unit 440 may generate a scheduling plan that designates a driving order for the plurality of selected information output units 300. The information processing unit 440 may generate a driving signal according to the scheduling plan and transmit the driving signal to the information output units 300.

The controller 450 is a type of central processing unit, and may control the entire process of connecting to the program storage unit 420 to process information and outputting the result of processing the information to the information output apparatus 1000 in the case where the information output apparatus 1000 receives an information request signal by connecting to an external apparatus or generates the information internally.

In the present embodiment, the controller 450 may include any type of device capable of processing any information, such as a processor. Here, the “processor” may refer, for example, to a data processing unit built in hardware, which has a circuit physically structured to perform a function expressed by a code or command included in a program. An example of the data processing unit built in the hardware as described above may include a processing unit such as a microprocessor, a central processing unit (CPU), a processor core, a multiprocessor, an application-specific integrated circuit (ASIC), or a field programmable gate array (FPGA), but the scope of the inventive concepts are not limited thereto.

FIG. 9 is a diagram illustrating an example of other components of an information output apparatus according to the present embodiment.

Referring to FIG. 9, an information output apparatus 900 may include an information output portion 910, a processor 920, and a memory 930. The information output portion 910 may include a first information output portion 910-1 and a second information output portion 910-2. Here, the first and second information output portions 910-1 and 910-2 may correspond to the first and second information output portions 100-1 and 100-2 of FIG. 6, the memory 930 may correspond to the storage medium 410 of FIG. 6, and the processor 920 may include the information processing unit 440 and controller 450 of FIG. 6.

The first information output portion 910-1 may include first information output cells that include a preset number of first information output units formed to enable tactilely sensing in the event of upward movement or downward movement in at least one direction and are arranged in a grid structure. The first information output portion 910-1 may be formed, for example, in a polygonal or elliptical shape.

The second information output portion 910-2 may be provided at a different location from the first information output portion 910-1 and include second information output cells that include a preset number of second information output units and are arranged in a grid structure. The second information output portion 910-2 may be formed, for example, in a polygonal shape (e.g., a rectangular shape), or may be formed in a polygonal or elliptical shape (e.g., a tube) including a hole. In the case where the second information output portion 910-2 has a polygonal shape or elliptical shape including a hole, the first information output portion 910-1 may arranged inside the hole.

In the present embodiment, a size of the first information output portion 910-1 may be configured to be greater than a size of the second information output portion 910-2. In an embodiment, the second information output portion 910-2 may be spaced

apart from the first information output portion 910-1 by a set interval and be provided in a horizontal direction or a vertical direction. For example, the second information output portion 910-2 may include a horizontal information output portion provided in the horizontal direction under the first information output portion 910-1 and a vertical information output portion provided in the vertical direction on the right side of the first information output portion 910-1.

The processor 920 may receive as an input, for example, content acquired by a camera module (not shown) included within the information output apparatus 900 or content transmitted from an external terminal (e.g., a smartphone), and detect one or more of an image and a text from the input content. Here, the processor 920 may detect, for example, the text from the content by using an optical character reader (OCR) method. An OCR is a technology that reads text from content such as a photo, and may indicate converting the text within the content into a format such as a character code that may be edited by a computer. More particularly, the OCR is a method of including text detection for detecting a text area and text recognition for recognizing text in the detected area, and extracting the text within the content through the same.

The text detected from the content may be information associated with the image detected from the content (e.g., naming information naming a key subject within the image, a famous sentence associated with the key subject, or the like), but is not limited thereto, and may include information that is not associated with the image.

The processor 920 may generate a first driving signal for driving a first information output unit according to the result of detecting the image and transmit the driving signal to the first information output portion 910-1 and thus enables the image to be output from the first information output portion 910-1 and enables the image to be intuitively recognized through tactile sensation.

Here, the processor 920 may perform image processing (e.g., semantic rendering processing, binarized image generation) on the image detected from the content and generate a first driving signal on the basis of the result of performing the image processing.

The processor 920 may partition the image into one or more of a background and a key subject through semantic rendering processing on the image, and generate a sub-image including the key subject and a feature of the key subject. Here, the key subject may be, for example, a person. In addition, the feature of the key subject may be information that distinguishes an outline, face, eyebrows, hair, forehead, or the like of the person. As an example of generating a driving signal for the first information output unit, the processor 920 may generate, on the basis of the key subject detected from the sub-image (or the image detected from the content), a matching image for an output of the key subject by displaying a flag in at least one unit cell from among unit cells of a set size, generate a driving signal for the first information output unit on the basis of the matching image, and transmit the driving signal to the first information output portion 910-1.

In detail, the processor 920 may partition the sub-image (or the image detected from the content) into equal square areas of a set size and generate the matching image for the output of the key subject on the basis of the square areas corresponding to the key subject detected from the sub-image. Here, the processor 920 may provide a guide image for outputting the key subject to the first information output portion 910-1 by displaying a flag in unit cells that match, on a one-to-one basis, the square areas corresponding to the key subject within the sub-image, from among a unit area formed of unit cells of a set size to generate the matching image for the output of the key subject. Here, coordinate information of the unit cells may match coordinate information of a first information output cell on a one-to-one basis while matching, on a one-to-one basis, coordinate information of the square areas partitioned in the sub-image. Here, the unit cells within the unit area may match the square areas partitioned in the sub-image on a one-to-one basis, but are not limited thereto, and may match on a one-to-many basis (1 n, n is a natural number) or on a many-to-one basis (n:1). For example, one unit cell may match four square areas. The number n of square areas matching one unit cell may be set to a particular number in advance, or may be set on the basis of a size of the sub-image (or the number of pixels, a size of the key subject).

The processor 920 may generate a driving signal for the first information output unit on the basis of a flag displayed in the matching image for the key subject and transmit the same to the first information output portion 910-1. In other words, the processor 920 may check, in the matching image, the coordinate information of the unit cells in which the flag is displayed in relation to the key subject and detect, from first matching information stored in the memory 930, the coordinate information of the first information output cell corresponding to the coordinate information of the unit cells. The processor 920 may generate a driving signal for first information output units in response to the coordinate information of the first information output cell and transmit the driving signal for the first information output units to the first information output portion 910-1.

In an embodiment, the processor 920 may detect, from the memory 930, any one reference key subject having a similarity of a reference value or more to the key subject of the image (a reference key subject corresponding to the key subject of the image) and generate, from the reference key subject, a matching image for an output of the reference key subject. Here, the processor 920 may generate the matching image for the output of the reference key subject by generating an image including the reference key subject, partitioning the image into equal square areas of a set size, and then, from among a unit area formed of unit cells of a set size, displaying a flag in unit cells that match, on a one-to-one basis, square areas corresponding to the reference key subject. Here, the processor 920 may generate an image having a size matching (or proportional to) a unit area of the matching image by including a set value (e.g., “0”) other than an area of the reference key subject. In addition, the coordinate information of the unit cell may match, on a one-to-one basis, coordinate information of the square areas partitioned in the image including the reference key subject and may match the coordinate information of the first information output cell on a one-to-one basis.

The processor 920 may generate a driving signal for a first information output unit on the basis of the matching image for the output of the reference key subject and transmit the driving signal to the first information output portion 910-1. In other words, the processor 920 may check, in the matching image, coordinate information of unit cells in which a flag is display in relation to the reference key subject and detect, from the first matching information stored in the memory 930, the coordinate information of the first information output cell corresponding to the coordinate information of the unit cells. The processor 920 may clearly display, on the first information output portion 910-1, the image detected from the content by using a structured reference key subject even in the case where the image detected from the content is distorted or partially unclear by generating a driving signal for first information output units in response to the coordinate information of the first information output cell and transmitting the driving signal for the first information output units to the first information output portion 910-1.

In another embodiment, the processor 920 may detect, from the memory 930, the matching image for the output of the reference key subject having a similarity of a reference value or more to the key subject of the image. The processor 920 may omit a process of generating the matching image from the reference key subject to quickly process an output of the image by generating a driving signal for a first information output unit on the basis of the matching image for the output of the reference key subject pre-stored in the memory 930 and transmitting the driving signal to the first information output portion 910-1.

In addition, as another example of generating the driving signal for the first information output unit, the processor 920 may process the sub-image to correspond to the coordinate information of the first information output cell, generate the driving signal for the first information output unit in response to the coordinate information, and transmit the driving signal to the first information output portion 910-1. In an embodiment, the processor 920 may generate a binarized image (a black and white image) for the sub-image by processing a portion indicating the feature of the key subject (or the key subject and the feature of the key subject) as a first value (e.g., “1”) and processing a portion excluded from the feature as a second value (e.g., “0”), and then process the binarized image to correspond to the coordinate information of the first information output cell. Here, on the basis of a preset binarization threshold value, the processor 920 may generate the binarized image from the sub-image by processing a pixel of the portion indicating the feature of the key subject as the first value and processing a pixel of the portion excluded from the feature as the second value. The binarization threshold value, which is a reference for binarization, may be adjusted by the size of the key subject, brightness of the sub-image, or the like.

As a method for allowing the binarized image to correspond to the coordinate information of the first information output cell, first, the processor 920 may output the binarized image in a virtual display area which is partitioned into a plurality of grid cells and in which one grid cell matches one first information output cell on a one-to-one basis.

The processor 920 may detect coordinate information of a first information output cell corresponding to coordinate information of a grid cell in which the binarized image is output, generate a driving signal for a first information output unit corresponding to the coordinate information of the first information output cell, and transmit the driving signal to the first information output portion 910-1. Here, the processor 920 may acquire, from the memory 930, second matching information including a one-to-one correspondence between coordinate information of a plurality of grid cells included in the virtual display area and the coordinate information of the first information output cell and detect, from the second matching information, coordinate information of a first information output cell corresponding to coordinate information of a grid cell in which the binarized image is output.

As another example, the processor 920 may detect, from the memory 930, any one reference key subject having a similarity of a reference value or more to the key subject of the image (a reference key subject corresponding to the key subject of the image), generate a reference binarized image from the reference key subject, and process the reference binarized image to correspond to the coordinate information of the first information output cell.

As another example, the processor 920 may detect, from the memory 930, a reference binarized image for the reference key subject having the similarity of the reference value or more to the key subject of the image and process the reference binarized image to correspond to the coordinate information of the first information output cell.

As another example, the processor 920 may perform image processing on the image detected from the content to partition the image into one or more of a background and a key subject. The processor 920 may differently generate, for each of the background and the key subject, a driving signal for a first information output unit. The processor 920 may generate a 1^{st}-1 driving signal that causes a first information output unit corresponding to the background to be depressed and transmit the 1^{st}-1 driving signal to the first information output portion 910-1. The processor 920 may generate a 1^{st}-2 driving signal that causes a first information output unit corresponding to the key subject of the image to protrude and transmit the 1^{st}-2 driving signal to the first information output portion 910-1. Accordingly, a user may intuitively recognize the key subject simply by touching the first information output portion 910-1.

In addition, the processor 920 enables the text associated with the image, which is output from the first information output portion 910-1, to be recognized through tactile sensation by generating a second driving signal for driving a second information output unit according to the result of detecting the text from the content and transmitting the second driving signal to the second information output portion 910-2 to allow the text to be output to the second information output portion 910-2. Here, the processor 920 may convert the text into Braille on the basis of a Braille table stored in the memory 930, generate a driving signal for a second information output unit corresponding to the Braille, and transmit the driving signal to the second information output portion 910-2.

As another example, the processor 920 may detect, from the memory 930, the text naming the reference key subject corresponding to the key subject of the image detected from the content, convert the text into Braille, generate the driving signal for the second information output unit corresponding to the Braille, and transmit the driving signal to the second information output portion 910-2. Even in the case where only the image is included in the content and the text is not included, the processor 920 allows information regarding the image (e.g., a name of a person, a brand name, and the like) to be accurately recognized by acquiring, from the memory 930, the text associated with the image and providing the text.

Here, the processor 920 compares two pieces of text in the case where the text is detected from the content together with the image and the text naming the reference key subject is detected from the memory 930 and in the case where the two pieces of text are different as the result of the comparison and allows both the two pieces of text to be output to the second information output portion 910-2 or allows any one piece of the text to be output to the second information output portion 910-2 on the basis of a size of the second information output portion 910-2 (or selection by the user).

In an embodiment, in the case where determining that a preset condition is satisfied, the processor 920 may change output locations of the image and the text by generating a first driving signal according to the result of detecting the text, transmitting the driving signal to the first information output portion 910-1, generating a second driving signal according to the result of detecting the image, and transmitting the driving signal to the second information output portion 910-2. In the case where the number of Braille characters converted from the text exceeds the maximum number of Braille characters output to the second information output portion 910-2 (or the set number of Braille characters) and the image may be output from the second information output portion 910-2, the processor 920 may determine that the condition is satisfied. The case where the image may be output from the second information output portion 910-2 may indicate that the number of cases where a size of the second information output portion 910-2 is greater than a size of the key subject within the image (or a case where the binarized image for the key subject may be output in the virtual display area including a plurality of grid cells that match, on a one-to-one basis, an information output cell within the second information output portion 910-2) is greater than the number of pixels included in the key subject. Here, the processor 920 may adjust (reduce, enlarge) the size (or an aspect ratio) of the key subject within the image and determine, on the basis of the adjusted size of the key subject, whether or not the image may be output from the second information output portion 910-2.

In an embodiment, a plurality of second information output portions 910-2 may be provided. In the case where a plurality of second information output portions 910-2 are provided, at least one of the plurality of second information output portions 910-2 may be selected on the basis of a preset priority, and a driving signal for driving an information output unit included in the selected information output portion according to the result of detecting the text may be generated and transmitted to the selected information output portion.

In the case where the second information output portion 910-2 includes a horizontal information output portion and a vertical information output portion and a priority of the horizontal information output portion is higher than a priority of the vertical information output portion, the processor 920 may select the horizontal information output portion, generate a driving signal for driving an information output unit included in the horizontal information output portion according to the result of detecting the text, and transmit the driving signal to the horizontal information output portion. Here, in the case where the number of Braille characters converted from the text exceeds the maximum number of Braille characters output from the horizontal information output portion (e.g., the number of characters that may be simultaneously displayed) (or the set number of Braille characters), the processor 920 may select both the horizontal information output portion and the vertical information output portion.

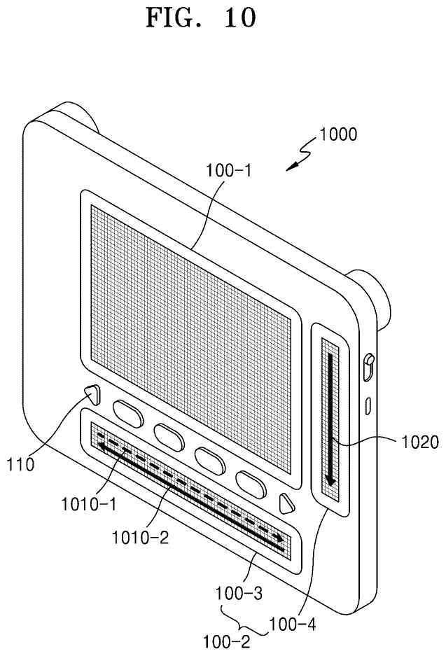

In the case where both the horizontal information output portion and the vertical information output portion are selected, the processor 920 may minimize a movement line for hand movement of the user for Braille reading by adjusting a Braille reading direction (a Braille output direction) in any one information output portion of the horizontal information output portion and the vertical information output portion. For example, the processor 920 may adjust the driving signal transmitted to the horizontal information output portion to change the Braille reading direction for the text in the horizontal information output portion on the basis of the Braille reading direction for the text in the vertical information output portion. A detailed example thereof is described below with reference to FIG. 10.

In an embodiment, the processor 920 may be linked to a request for additional information regarding the image to receive the additional information regarding the image from an external server (or a terminal), generate a second driving signal for driving a second information output unit according to the result of detecting text from the additional information, and transmit the second driving signal to the second information output portion 910-2. Here, in the case where a plurality of second information output portions 910-2 (e.g., the horizontal information output portion and the vertical information output portion) are included, the processor 920 may cause one second information output portion (e.g., the horizontal information output portion) to display the Braille characters converted from the text detected from the content and cause another one second information output portion (e.g., the vertical information output portion) to display the Braille characters converted from the text detected from the additional information. For example, in the case where the key subject of the image detected from the content is a face of a person A and the text detected from the content is the person A (a name of the person), the additional information regarding the image may be, for example, personal information regarding the person A (a body size, education, family, and the like). In addition, in the case where the key subject of the image detected from the content is in the form of a product B and the text detected from the content is a name of the product B, the additional information regarding the image may be, for example, sales information regarding the product B (a store, a location of the store, a price, a review, and the like).

The processor 920 may allow the user to intuitively recognize the image through tactile sensation and simultaneously check detailed information regarding the image by providing the additional information regarding the image through an information output portion together with the image detected from the content and the text associated with the image.

Also, in another embodiment, in the case where the second information output portion 910-2 is provided in a polygonal or elliptical shape including a hole, the processor 920 may generate a second driving signal to allow Braille for text to be output from the second information output portion 910-2 in a preset Braille reading direction (e.g., clockwise, counterclockwise) from a preset point (e.g., from a point in a 12 o'clock direction).

The memory 930 may store the reference key subject and the text naming the reference key subject. The memory 930 may further store the reference binarized image for the reference key subject.

The memory 930 may further store the first matching information including one-to-one matching among the unit area of the matching image, the coordinate information of the unit cells within the unit area, and the coordinate information of the first information output cells. Here, the one-to-one matching may indicate that, under the premise that the number of unit cells and the number of first information output cells are the same, the coordinate information of the unit cells (relative locations in the unit area) and the coordinate information of the first information output cells (relative locations in the first information output portion 910-1) are the same.

The memory 930 may further store the second matching information including one-to-one matching among the virtual display area, the coordinate information of the plurality of grid cells included in the virtual display area, and the coordinate information of the first information output cell. Here, the one-to-one matching may indicate that, under the premise that the number of grid cells and the number of first information output cells are the same, the coordinate information of the grid cells (relative locations in the virtual display area) and the coordinate information of the first information output cell (a relative location in the first information output portion) are the same.

In addition, the memory 930 may further store the Braille table. The Braille table may include, for example, Braille characters for Braille, which include abbreviations (articles, . . . , but, therefore, and so, etc.), numbers (1, 2, 3, . . . , 0), signs (?,!, +, . . . ), the English alphabet (A, B, C, . . . , Z), or the like.

FIG. 10 is a view illustrating another example of the appearance of an information output apparatus according to the present embodiment. In the following description, the description of the same portion as the description of FIGS. 1 and 9 is omitted.

Referring to FIG. 10, an information output apparatus 1000 may include a first information output portion 100-1, a second information output portion 100-2, and a plurality of user interfaces 110.

The first information output portion 100-1 may be provided, for example, in a rectangular shape, but is not limited thereto.

The second information output portion 100-2 may include a horizontal information output portion 100-3 and a vertical information output portion 100-4. The horizontal information output portion 100-3 and the vertical information output portion 100-4 may also be provided in a rectangular shape, but are not limited thereto.

The horizontal information output portion 100-3 may be spaced apart from the first information output portion 100-1 by a set interval thereunder and may be provided in a horizontal direction. The vertical information output portion 100-4 may be spaced apart from the first information output portion 100-1 by a set interval on the right side thereof and may be provided in a vertical direction.

A processor of the information output apparatus 1000 may select at least one information output portion from among the horizontal information output portion 100-3 and the vertical information output portion 100-4 on the basis of a preset priority, generate a driving signal for driving an information output unit included in the selected information output portion according to the result of detecting text, and transmit the driving signal to the selected information output portion. For example, in the case where a priority of the vertical information output portion 100-4 is higher than a priority of the horizontal information output portion 100-3, the processor may select the vertical information output portion 100-4, generate a driving signal for driving an information output unit included in the vertical information output portion 100-4 according to the result of detecting the text, and transmit the driving signal to the vertical information output portion 100-4.

In an embodiment, in the case where the number of Braille characters converted from the text exceeds the maximum number of Braille characters that are output from the horizontal information output portion 100-3 (e.g., the number of characters that may be simultaneously displayed) (or the set number of Braille characters), the processor of the information output apparatus 1000 may select both the horizontal information output portion 100-3 and the vertical information output portion 100-4.

In the case where both the horizontal information output portion 100-3 and the vertical information output portion 100-4 are selected, the processor of the information output apparatus 1000 may adjust the driving signal transmitted to the horizontal information output portion 100-3 to change a Braille reading direction for the text in the horizontal information output portion 100-3 on the basis of a Braille reading direction for the text in the vertical information output portion 100-4. For example, in the case where the Braille reading direction in the vertical information output portion 100-4 provided on the right side on the basis of the first information output portion 100-1 is from top to bottom 1020 and the Braille reading direction in the horizontal information output portion 100-3 provided at a lower end on the basis of the first information output portion 100-1 is from left to right 1010-1, the processor may adjust the driving signal transmitted to the horizontal information output portion 100-3 to allow the Braille reading direction in the horizontal information output portion 100-3 to be changed from right to left 1010-2. The processor may minimize a movement line for hand movement of a user for Braille reading by allowing the Braille reading direction in the horizontal information output portion 100-3 to be changed to reduce a distance between a last Braille character (a last Braille character to be read) in the vertical information output portion 100-4 and a first Braille character (a first Braille character to be read) in the horizontal information output portion 100-3.

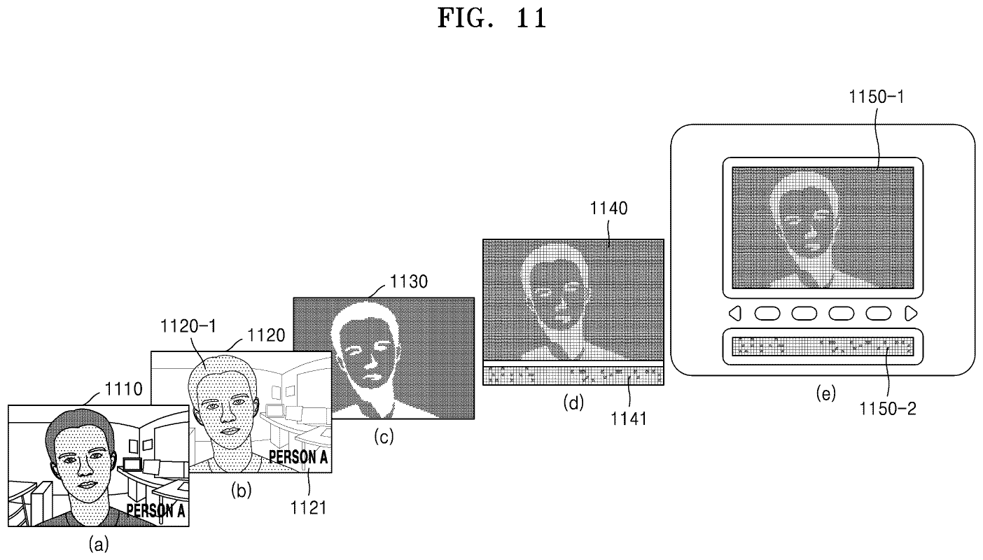

FIG. 11 is a view illustrating an example of image processing in an information output apparatus according to the present embodiment.

Referring to FIG. 11, in an embodiment, a processor of an information output apparatus may receive content 1110 as an input (a), and detect an image 1120 (an image including a face of a person A) and text 1121 (the person A) from the content 1110 (b). Here, the processor simplifies, for example, a color and contrast of the image through gray scale and then facilitates extraction of a key subject 1120-1 (the face of the person A).

The processor may partition the image 1120 into one or more of a background and p the key subject 1120-1 through semantic rendering processing on the image 1120 and generate a sub-image including the key subject 1120-1 and a feature of the key subject 1120-1. In an embodiment, the processor may extract the key subject 1120-1 from which the background is removed, by applying a background removal algorithm pre-trained to remove the background from the image 1120 or may extract the key subject 1120-1 by applying a subject extraction algorithm pre-trained to extract a subject form the image 1120. Here, a type of the background removal algorithm or the subject extraction algorithm may include, for example, a gaussian mixture model (GMM), an adaptive mixture of gaussians (MOG), and the like. The processor may generate a binarized image 1130 by processing a portion indicating a feature of the key subject 1120-1 as a first value (e.g., “1”, white) and processing a portion excluded from the feature as a second value (e.g., “0”, black) with respect to the sub-image (c). The processor may output the binarized image 1130 in a virtual display area 1140 (d). The virtual display area 1140 may be partitioned into a plurality of grid cells. One grid cell may match, on a one-to-one basis, one first information output cell included in a first information output portion 1150-1. Here, the processor may adjust (or reduce or enlarge) a size (an aspect ratio) of the binarized image 1130 so that the binarized image 1130 is optimized on the basis of a size of the virtual display area 1140.

The processor may detect coordinate information of a first information output cell corresponding to coordinate information of a grid cell in which the binarized image 1130 is output, generate a driving signal for a first information output unit corresponding to the coordinate information of the first information output cell, and transmit the driving signal to the first information output portion 1150-1 (e).

In addition, the processor may convert the text 1121 (the person A) detected from the content 110 into Braille characters (1141) (d), generate a driving signal for a second information output unit corresponding to the Braille characters 1141, and transmit the driving signal to a second information output portion 1150-2 (e).

The processor enables a name referring to the key subject 1120-1 to be easily sensed together with a shape (or an outline) of the key subject 1120-1 (e.g., a face shape of the person A) within the image 1120 through tactile sensation by processing the image 1120 (the image including the face of the person A) detected from the content 1110 and the text 1121 (the person A) to be output to the first information output portion 1150-1 and the second information output portion 1150-2.

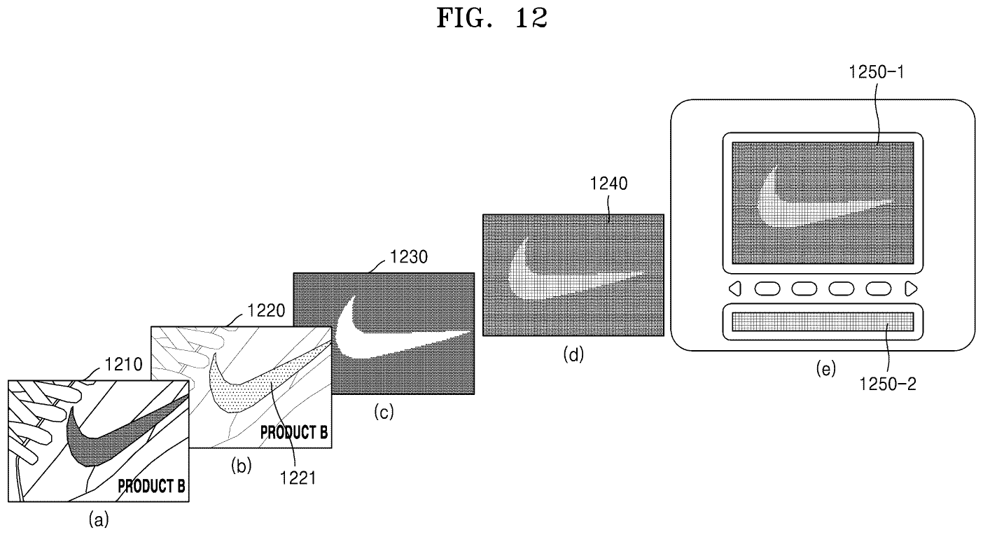

FIG. 12 is a view illustrating another example of image processing in an information output apparatus according to the present embodiment. In the following description, the description of the same portion as the description of FIG. 11 is omitted.

Referring to FIG. 12, in an embodiment, a processor of an information output apparatus may receive content 1210 as an input (a) and detect an image 1220 from the content 1210 (b).

The processor may detect, from a memory, a reference key subject corresponding to a key subject 1221 (a brand logo) of the image 1220 (an image including the brand logo), generate a reference binarized image 1230 from the reference key subject, and output the same in a virtual display area 1240. The virtual display area 1240 may be partitioned into a plurality of grid cells, and one grid cell may match one first information output cell on a one-to-one basis.

Alternatively, the reference binarized image 1230, and/or the virtual display area 1240 partitioned into the grid cells may be generated in advance in correspondence to the reference key subject stored in the memory and then stored in the memory. Accordingly, in the case where the processor completes a task of matching the detected key subject 1221 with the reference key subject stored in the memory, the processor may retrieve, from the memory, the reference binarized image 1230 corresponding to the reference key subject and/or the virtual display area 1240 partitioned into the grid cells.

The processor may detect coordinate information of a first information output cell corresponding to coordinate information of a grid cell in which the reference binarized image 1230 is output, generate a driving signal for a first information output unit corresponding to the coordinate information of the first information output cell, and transmit the driving signal to a first information output portion.

The processor may detect, from the memory, text (a brand N) naming the reference key subject (a reference brand logo) corresponding to the key subject 1221 (the brand logo) of the image 1220, convert the text into Braille characters, generate a driving signal for a second information output unit corresponding to the Braille characters, transmit the driving signal to a second information output portion 1250-2.

In an embodiment, the processor may allow information regarding the image 1220 (e.g., a brand name indicated by the brand logo) to be easily recognized and the image 1220 to be identified even in the case where text associated with the image 1220 is not included in the content 1210, by processing the text (e.g., the brand N) associated with the image 1220 and outputting the same to the second information output portion 1250-2 while processing the image 1220 detected from the content 1210 (the image including the brand logo) and outputting the same to a first information output portion 1250-1.

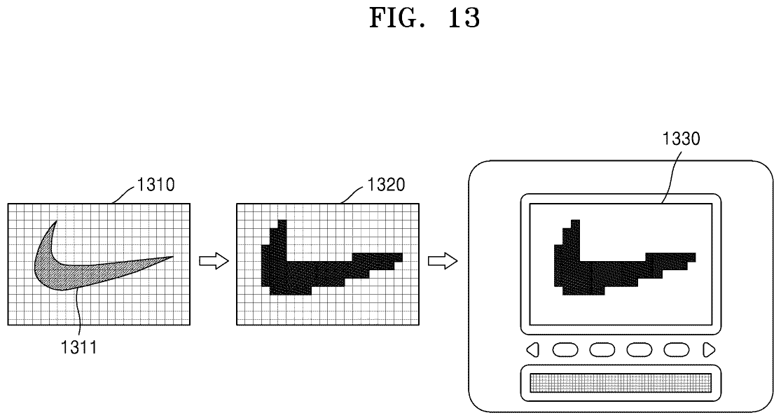

FIG. 13 is a view illustrating another example of image processing in an information output apparatus according to the present embodiment.

Referring to FIG. 13, a processor of an information output apparatus may generate, on the basis of a key subject detected in an image, a matching image for an output of the key subject by displaying a flag in at least one unit cell from among unit cells of a set size, generate a driving signal for a first information output unit on the basis of the matching image, and transmit the driving signal to a first information output portion.

For example, the processor may partition an image 1310 into equal square areas of a set size and generate a matching image 1320 for an output of a key subject 1311 on the basis of the square areas corresponding to the key subject 1311 (a brand logo) within the image 1310. The processor may generate the matching image 1320 for the output of the key subject 1311 by displaying a flag in unit cells that match, on a one-to-one basis, square areas corresponding to the key subject 1311 within the image 1310, from among a unit area formed of unit cells of a set size. Here, coordinate information of the unit cells may match, on a one-to-one basis, coordinate information of a first information output cell of the information output apparatus while matching, on a one-to-one basis, coordinate information of the square areas partitioned in the image 1310. Also, the flag may be a set particular form or a set value (e.g., “1”).

In an embodiment, the processor may set the matching between the square areas and the unit cells to many-to-one matching (or one-to-many matching) on the basis of the number of square areas partitioned in the key subject 1311 in the image 1310 or a size of the key subject 1311 (the number of pixels) and generate the matching image 1320 for the output of the key subject 1311 on the basis of the set matching. For example, in the case where the number of square areas partitioned in the key subject 1311 in the image 1310 is greater than or equal to a set number or a size of the key subject 1311 (the number of pixels) is greater than or equal to a set size, the processor may reduce the key subject 1311 by setting the one-to-one matching between the square areas and the unit cells to a many-to-one matching (e.g., 4:1).

The processor may check coordinate information of the unit cells in which the flag is displayed in relation to the key subject 1311 in the matching image 1320 for the key subject 1311, and detect, from first matching information stored in a memory, the coordinate information of the first information output cell corresponding to the coordinate information of the unit cells. The processor enables the key subject 1311 within the image 1310 to be displayed in a first information output portion 1330 by generating a driving signal for first information output units in response to the coordinate information of the first information output cell and transmitting the driving signal to the first information output portion 1330.

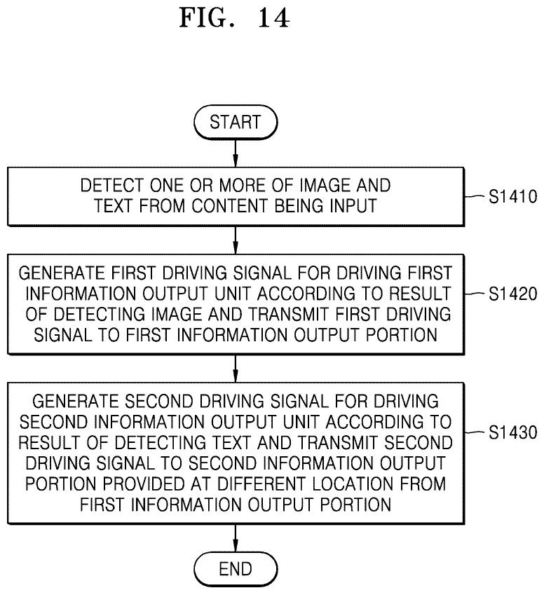

FIG. 14 is a flowchart illustrating an information output method according to the present embodiment. In the following description, the description of the same portion as the description of FIGS. 1 to 12 is omitted. The information output method may be performed by an information output apparatus according to the present embodiment.

Referring to FIG. 14, in operation S1410, the information output apparatus may detect one or more of an image and a text from content being input. Content acquired by a camera module included inside the information output apparatus or content transmitted from an external terminal (e.g., a smartphone) may be received as an input.

In operation S1420, the information output apparatus may allow the image to be displayed in a first information output portion to allow a shape (or an outline) of a key subject within the image to be intuitively recognized through tactile sensation by generating a first driving signal for driving a first information output unit according to the result of detecting the image and transmitting the first driving signal to the first information output portion. The first information output portion may include a first information output cell that includes a preset number of first information output units formed to tactilely sense in the event of upward movement or downward movement in at least one direction and is arranged in a grid structure.

In operation S1430, the information output apparatus may generate a second driving signal for driving a second information output unit according to the result of detecting the text and transmit the second driving signal to a second information output portion. The second information output portion may be provided at a different location from the first information output portion and include a second information output cell that includes a preset number of second information output units and is arranged in a grid structure.

In an embodiment, the information output apparatus allows the text to be displayed in the second information output portion, by converting the text detected from the content into Braille characters, generating a driving signal for a second information output unit corresponding to the Braille characters, and transmitting the driving signal to the second information output portion. The information output apparatus enables the text output from the second information output portion (e.g., a name indicating the key subject within the image) to be recognized through tactile sensation.

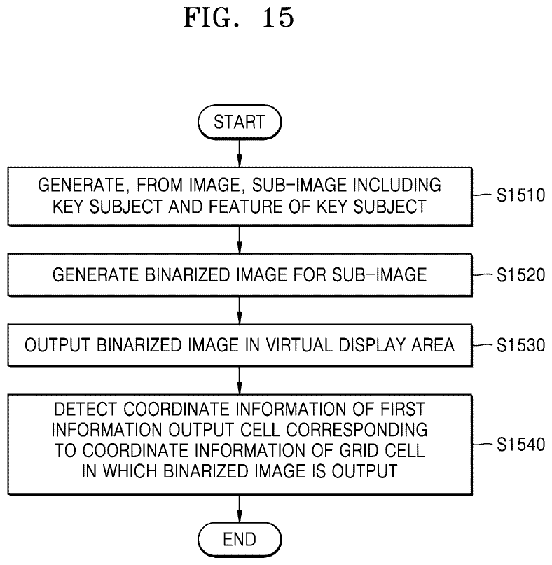

FIG. 15 is a flowchart illustrating an example of an image processing method in an information output apparatus, according to the present embodiment.

Referring to FIG. 15, in operation S1510, an information output apparatus may partition an image into one or more of a background and a key subject through semantic rendering processing on the image detected from content and generate a sub-image including the key subject and a feature of the key subject. Here, the key subject may be, for example, a person. In addition, the feature of the key subject may be information that distinguishes an outline, face, eyebrows, hair, and forehead of the person.

Hereinafter, through operations S1520 to S1540, the information output apparatus may process the sub-image to correspond to coordinate information of a first information output cell, generate a driving signal for a first information output unit in response to the coordinate information, and transmit the driving signal to a first information output portion.

In operation S1520, the information output apparatus may generate a binarized image for the sub-image. The information output apparatus may generate the binarized image (a black and white image) for the sub-image by processing a portion indicating the feature of the key subject as a first value (e.g., “1”) and processing a portion excluded from the feature as a second value (e.g., “0”). Here, the information output apparatus may generate the binarized image from the sub-image by processing a pixel of the portion indicating the feature of the key subject as the first value and a pixel of the portion excluded from the feature as the second value on the basis of a preset binarization threshold value. The binarization threshold value, which is a reference for binarization, may be adjusted by a size of the key subject, brightness of the sub-image, or the like.

In operation S1530, the information output apparatus may process the binarized image to correspond to the coordinate information of the first information output cell. Here, the information output apparatus may output the binarized image in a virtual display area which is partitioned into a plurality of grid cells and in which one grid cell matches the first information output cell on a one-to-one basis.

In an embodiment, the information output apparatus may detect, from a memory, any one reference key subject having a similarity of a reference value or more to the key subject of the image (a reference key subject corresponding to the key subject of the image), generate a reference binarized image from the reference key subject, and process the reference binarized image to correspond to the coordinate information of the first information output cell. Here, the information output apparatus may output the reference binarized image in the virtual display area which is partitioned into the plurality of grid cells and in which one grid cell matches the first information output cell on a one-to-one basis.

In operation S1540, the information output apparatus enables the image output from the first information output portion to be recognized through tactile sensation by detecting, from second matching information stored in the memory, the coordinate information of the first information output cell corresponding to coordinate information of a grid cell in which the binarized image (or the reference binarized image) is output, generating a driving signal for a first information output unit corresponding to the coordinate information of the first information output cell, and transmitting the driving signal to the first information output portion.

In an embodiment, in the case where the reference key subject corresponding to the key subject of the image is detected from the memory, in operation S1430 of FIG. 14, the information output apparatus may detect text naming the reference key subject from the memory, convert the text into Braille characters, generate a driving signal for a second information output unit corresponding to the Braille characters, and transmit the driving signal to the second information output portion. The information output apparatus provides the text associated with the image to enable the image to be particularly recognized even in the case where only the image is detected from the content and the text is not detected, by acquiring, from the memory, the text naming the reference key subject and allowing the same to be output to the second information output portion.

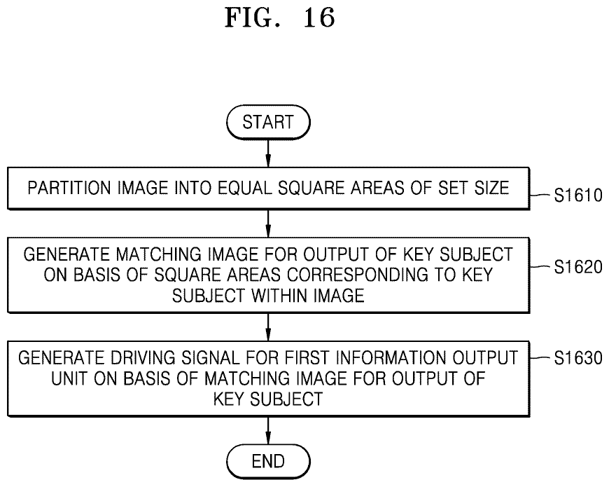

FIG. 16 is a flowchart illustrating another example of an image processing method in an information output apparatus, according to the present embodiment.

Referring to FIG. 16, in operation S1610, an information output apparatus may partition an image into equal square areas of a set size. Here, the image may be an image detected from content, a sub-image generated from the image to include a feature of a key subject, or a binarized image generated from the sub-image.

In operation S1620, the information output apparatus may generate a matching image for an output of the key subject on the basis of the square areas corresponding to the key subject within the image. The information output apparatus may generate the matching image for the output of the key subject by displaying a flag in unit cells that match, on a one-to-one basis, the square areas corresponding to the key subject within the image, from among a unit area formed of unit cells of a set size. Here, coordinate information of the unit cells may match, on a one-to-one basis, coordinate information of the square areas partitioned in the image and may match coordinate information of a first information output cell on a one-to-one basis.

In operation S1630, the information output apparatus may generate a driving signal for a first information output unit on the basis of the matching image for the output of the key subject and transmit the driving signal to a first information output portion. Here, the information output apparatus may check the coordinate information of the unit cells in which the flag is displayed in relation to the key subject in the matching image and detect, from first matching information stored in a memory, the coordinate information of the first information output cell corresponding to the coordinate information of the unit cells. The information output apparatus enables the key subject within the image to be displayed in the first information output portion by generating a driving signal for first information output units in response to the coordinate information of the first information output cell and transmitting the driving signal to the first information output units to the first information output portion.

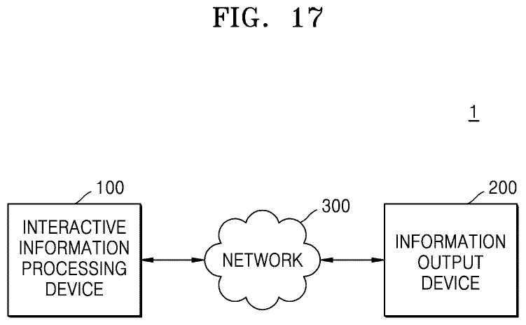

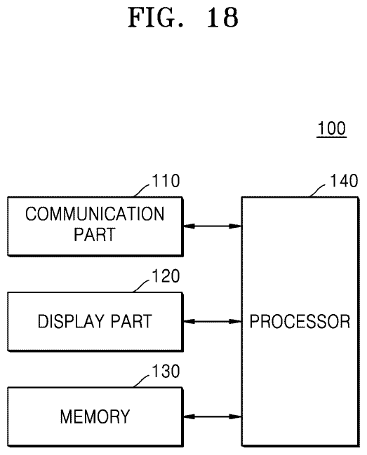

FIG. 17 is an illustration of an interactive information processing environment according to an embodiment of the inventive concepts. Referring to FIG. 17, the interactive information processing environment 1 may include an interactive information processing device 100, an information output device 200, and a network 300.

The interactive information processing device 100 may generate and transmit interactive information to the information output device 200. In this embodiment, the information output device 200 may include electronics for outputting tactile information via an upward drive or a downward drive of at least one information output section (240 in FIG. 26).

The interactive information processing device 100 may be information-compatible with the information output device 200. Here, the term ‘information-compatible’ may include the meaning that the interactive information processing device 100 stores the specification information and drive information of the information output device 200, so that the interactive information processing device 100 may generate interactive information based on the specification information and drive information of the information output device 200 and transmit the interactive information to the information output device 200, and the information output device 200 may output the interactive information received from the interactive information processing device 100 without any additional configuration. In an optional embodiment, the term ‘information-compatible’ may also include meaning that the tactile information output to the information output device 200 is transmitted to the interactive information processing device 100, so that the interactive information processing device 100 may output the tactile information as visual information.

In this embodiment, the term ‘interactive information’ may include a subset of information processed to convert visual information output to the interactive information processing device 100 into tactile information to the information output device 200. In this embodiment, the visual information output to the interactive information processing device 100 may also be included in the interactive information.

In this embodiment, the interactive information may specifically include one or more files previously stored in memory (130 in FIG. 18), such as files previously created in the first region and stored in memory, and files captured in the first region and stored in memory. The interactive information may also include files received via communication with an external device (e.g., a server, a user terminal, etc.).

Further, the interactive information may include a touch input generated by a real- time touch of the first region (181 in FIG. 20). Further, the interactive information may include a set of touch inputs generated by a touch of the first region until a touch signal for a print button (183a in FIG.20) embodied in a third region (183 in FIG. 20) at a location different from the first region is received. Such interactive information may include one or more of graphical information and textual information.

In this example, the specification information of the information output device 200 may include, for example, the number and size of information output regions, the number of information output sections included in the information output regions, the configuration and description of the user interface buttons, and the like. In addition, the driving information of the information output device 200 may include, for example, an operating power source, signals for upward operations or downward operations of the information output sections, and a communication method with the interactive information processing device 100. In an optional embodiment, the interactive information processing device 100 may receive specification information and drive information of the information output device 200 through communication with the information output device 200 and store the information in memory.

It may be seen from the specification information and drive information of the information output device 200 that in an embodiment, the information output device 200 is configured with a first information output region (210-1 in FIG. 25) and a second information output region (210-2 in FIG. 25) at a different location from the first information output region. The interactive information processing device 100 may generate drive signals for the information output sections to output graphical information in the first information output region, drive signals for the information output sections to output textual information in the second information output region, and transmit the drive signals to the information output device 200.

In this embodiment, the interactive information processing device 100 may exist independently in the form of a server, or the interactive information processing device 100 may implement the information processing function in the form of an application or software, which may be mounted on a user terminal (not shown).

Here, the user terminal may include a communication terminal capable of performing the functions of a computing device (not shown), and may include, but is not limited to, a user-operated desktop computer, smartphone,

laptop, tablet PC, smart TV, cell phone, personal digital assistant (PDA), media player, micro server, global positioning system (GPS) device, e-book device, digital broadcasting device, navigation, kiosk, MP3 player, digital camera, home appliance, and other mobile or non-mobile computing device. Such user devices are not limited to those described above, and any device capable of web browsing may be employed without limitation.

The information output device 200 may receive a drive signal for the information output section from the interactive information processing device 100 and output predetermined information to the information output region. In other words, the information output device 200 may be an electronic device capable of outputting Braille-based information for a visually impaired user. For example, the information output device 200 may include a Braille watch, a Braille pad, or the like.

The network 300 may serve to connect the interactive information processing device 100 and the information output device 200. The network 300 may include, for example, a wired network, such as a local region network (LAN), wide region network (WAN), metropolitan region network (MAN), integrated service digital network (ISDN), or a wireless network, such as a wireless LAN (WLAN), code-division multiple access (CDMA), or satellite communication, but the scope of the invention is not limited thereto. Further, the network 300 may transmit and receive information using short-range communication and/or long-range communication. Here, the short-range communication may include Bluetooth, radio frequency identification (RFID), infrared data association (IrDA), ultra-wideband (UWB), ZigBee, and Wi-Fi technologies, and the long-range communication may include code-division multiple access (CDMA), frequency-division multiple access (FDMA), time-division multiple access (TDMA), orthogonal frequency-division multiple access (OFDMA), and single carrier frequency-division multiple access (SC-FDMA) technologies.

The network 300 may include a connection of network elements such as hubs, bridges, routers, and switches. The network 300 may include one or more connected networks, such as a multi-network environment, including a public network, such as the Internet, and a private network, such as a secure corporate private network. Access to the network 300 may be provided via one or more wired or wireless access networks.

Furthermore, the network 300 may support communication technologies, such as controller region network (CAN) communications, vehicle to infrastructure (V2I) communications, vehicle to everything (V2X) communications, wireless access in vehicular environment (WAVE) communications, etc., Internet of Things (IoT) networks and/or 5G communications to exchange and process information between distributed components, such as objects.

FIG. 18 is a schematic block diagram illustrating the configuration of an interactive information processing device according to an embodiment. In the following description, portions of the description that duplicate the description of FIG. 17 will be omitted. Referring to FIG. 18, the interactive information processing device 100 may include a communication part 110, a display part 120, a memory 130, and a processor 140.

The communication part 110 may provide a communication interface required to deliver transmission/reception signals in the form of packet data between the information output device 200 and the network 300. Further, the communication part 110 may serve to receive predetermined information request signals from the information output device 200 and to transmit the information processed by the processor 140 to the information output device 200. Here, the communication interface may include a medium that serves to connect the interactive information processing device 100 and the information output device 200, such as a path that provides an access path for the information output device 200 to send and receive information after being connected to the interactive information processing device 100. The communication part 110 may also be a device that includes hardware and software necessary to transmit and receive signals, such as control signals or data signals, via wired or wireless connections with other network devices.

The display part 120 may output information associated with the operation of the interactive information processing device 100 as visual data, and may be embodied as a touch screen (not shown) by being layered or integrally formed with a touch sensor. Such a touch screen may function as a user input part that provides an input interface to a user.

The display part 120 may refer to a control panel capable of inputting and outputting information associated with the interactive information processing device 100, as well as being configured to display information associated with the interactive information processing device 100. The display part 120 may be, for example, a predetermined display member such as organic light emitting displays (OLEDs) or liquid crystal displays (LCDs) or light emitting displays (LEDs) capable of touch recognition.

The input interface provided to a user in this embodiment may further include a microphone (not shown) that is capable of inputting an audio signal. The microphone is an exemplary embodiment, the location and implementation method thereof are not limited, and input means for inputting audio signals may be employed without limitation. The touch screen is also an exemplary embodiment, and the location and implementation method thereof are not limited, and input means for inputting user request signals may be employed without limitation.

On the other hand, in this embodiment, the output interface may further include a speaker (not shown). The speaker may output information associated with the operation of the interactive information processing device 100 as auditory data. In other words, the speaker may output information associated with the operation of the interactive information processing device 100 as audio data, for example, notification messages such as warning sounds, notification sounds, error conditions, information corresponding to the user's voice command, processing results corresponding to the user's voice command, etc., under the control of the processor 140. The speaker may be an exemplary embodiment, and may include any output means for outputting audio signals, without limitation of the location and implementation method thereof.

The memory 130 may store codes that are associated with the processor 140 and, when executed by the processor 140, cause the processor 140 to support various functions of the interactive information processing device 100. That is, the memory 130 may store a number of applications (application programs or applications) running on the interactive information processing device 100, information and instructions for the operation of the interactive information processing device 100. At least some of these applications may be downloaded from an external server via wireless communication. Additionally, the memory 130 may store information about one or more users who wish to interact with the interactive information processing device 100. Such user information may include authorization information (e.g., facial and body shape information, voice information, etc.) that may be used to identify the recognized user.

Additionally, the memory 130 may store information about actions to be performed by the interactive information processing device 100 in response to voice commands from the user (e.g., commands to control the interactive information processing device 100).

In this embodiment, the memory 130 may perform a function of temporarily or permanently storing data processed by the processor 140. Here, the memory 130 may include magnetic storage media or flash storage media, but the scope of the invention is not limited thereto. Such memory 130 may include internal memory and/or external memory, and may include volatile memory such as DRAM, SRAM, or SDRAM, non-volatile memory such as one time programmable ROM (OTPROM), PROM, EPROM, EEPROM, mask ROM, flash ROM, NAND flash memory, or NOR flash memory, flash drives such as SSDs, compact flash (CF) cards, SD cards, Micro-SD cards, Mini-SD cards, XD cards, or memory sticks, or storage devices such as HDDs.

The processor 140 is a type of central processing unit (CPU) that may control the overall operation of the interactive information processing device 100 by executing control software loaded in the memory 130. The processor 140 may refer to a hardware-embedded data processing device having, for example, physically structured circuits to perform functions expressed by codes or instructions included in a program. Examples of such hardware-embedded data processing devices may include, but are not limited to, processing devices such as a microprocessor, a central processing unit (CPU), a processor core, a multiprocessor, an application-specific integrated circuit (ASIC), a field programmable gate array (FPGA), and the like.

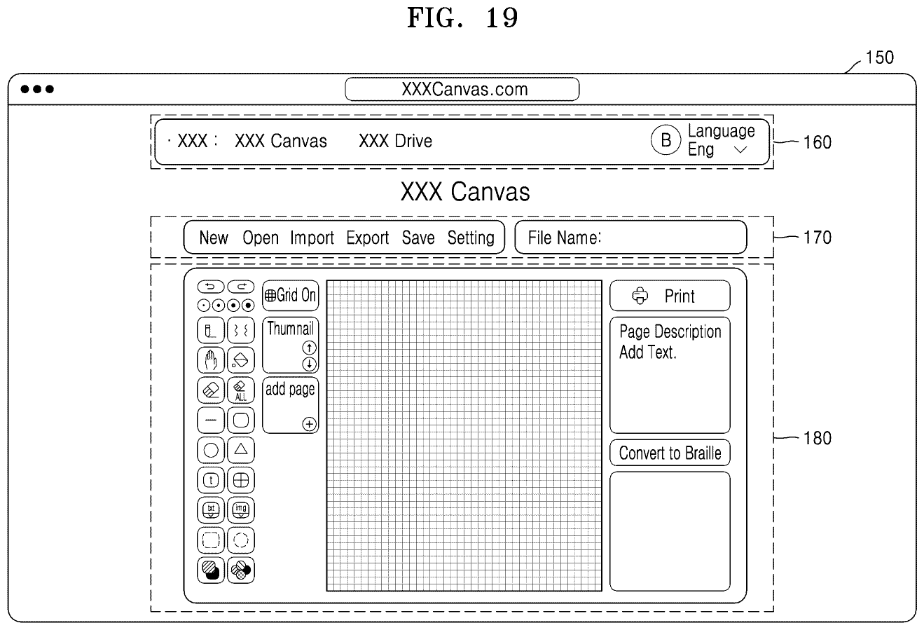

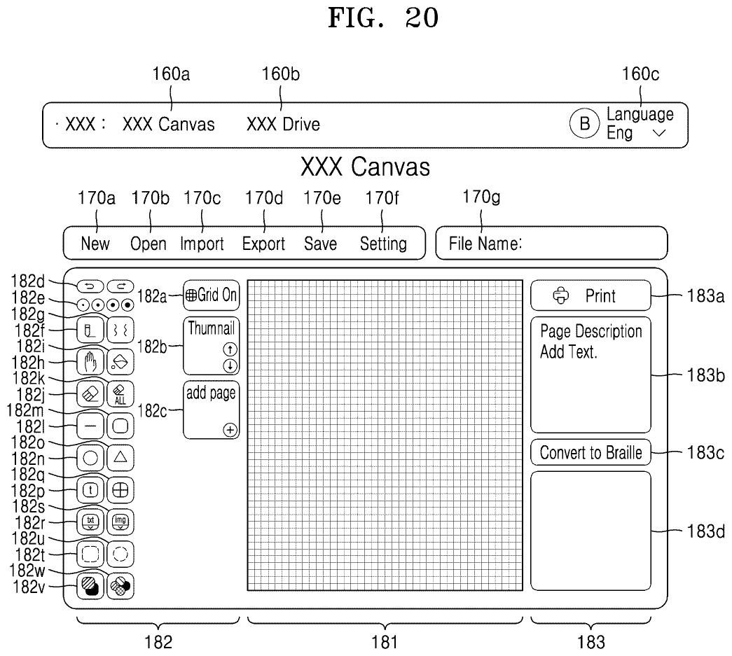

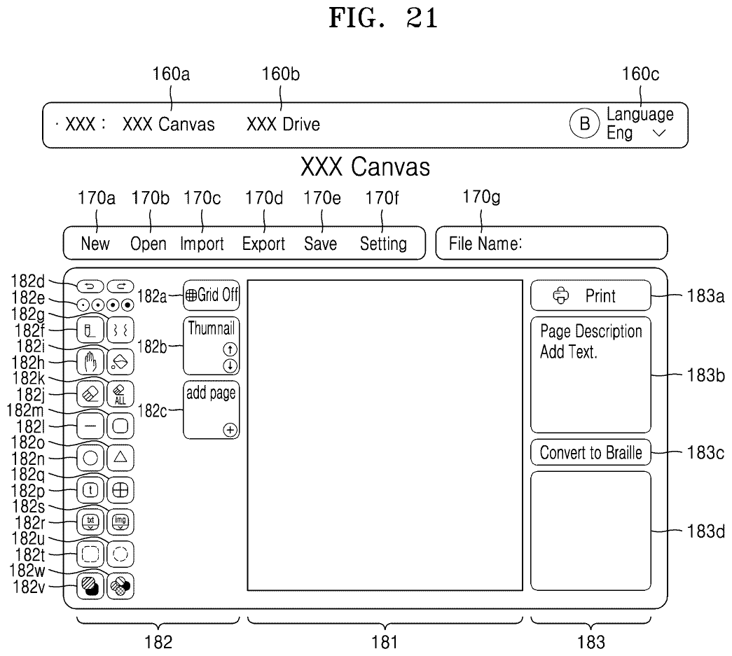

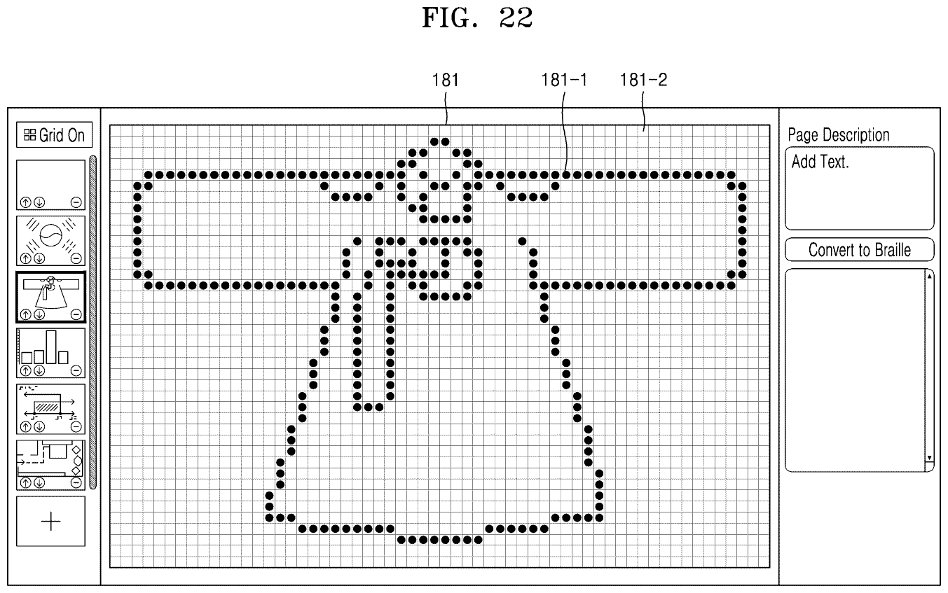

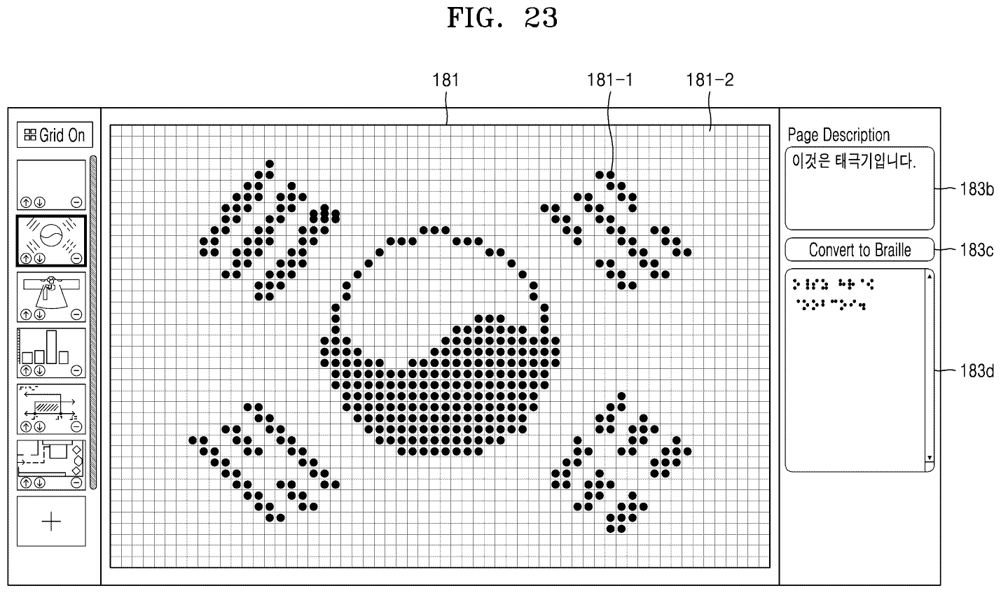

The processor 140 may output a user interface screen (150 in FIG. 19) to the display part 120. The processor 140 may generate and output response information corresponding to a user's touch on the user interface screen.

The processor 140 may output interactive information compatible with the information output device 200 in a first region (181 in FIG. 20) divided into a plurality of grid cells configuring the user interface screen.

The processor 140 may detect coordinate information of a grid cell corresponding to the interactive information output in the first region. Each of the plurality of grid cells configuring the first region may have coordinate information previously set, for example, from (1, 1) to (N, M), which may be stored in the memory 130.

When interactive information is output in the first region, grid cells of the first region may be categorized into grid cells (e.g., 181-1 in FIG. 22) displaying meaningful information and grid cells (e.g., 181-2 in FIG. 22) displaying non-meaningful information. The processor 140 may detect coordinate information of the grid cells displaying meaningful information and of the grid cells displaying meaningless information.

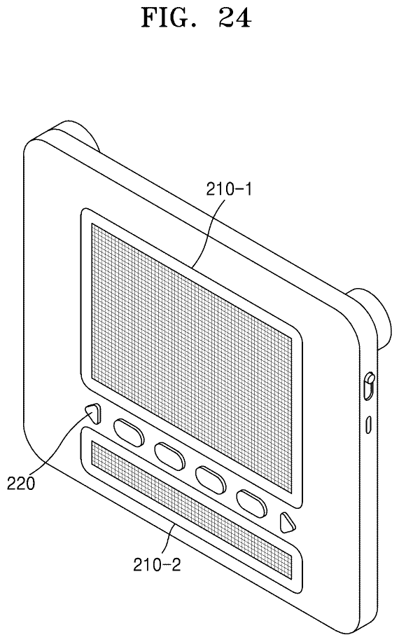

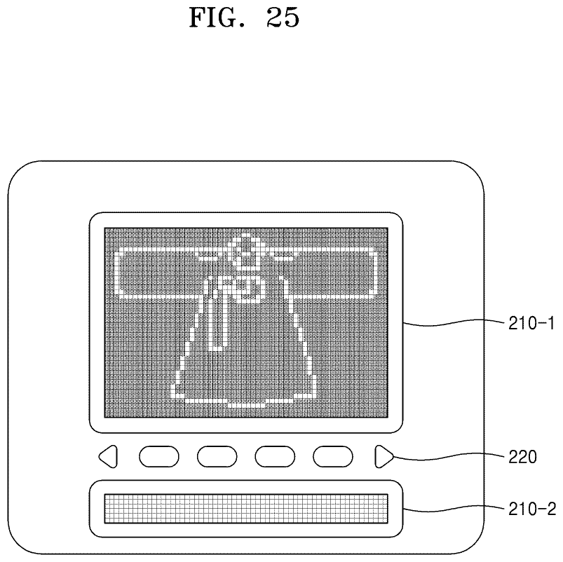

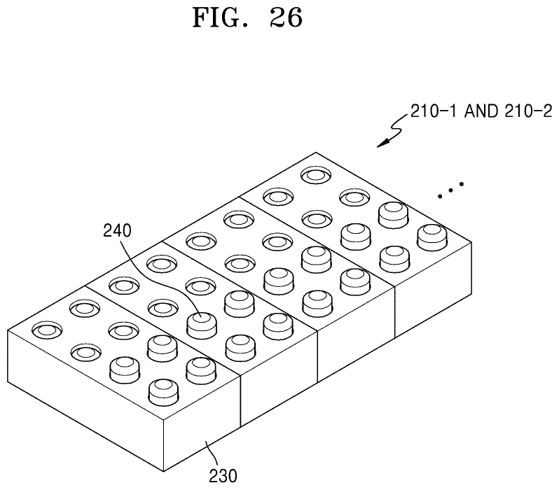

The processor 140 may detect coordinate information of the information output cell (230 in FIG. 26) that is a one-to-one match to the coordinate information of the grid cell. Here, one-to-one matching may mean that the number of grid cells configuring the first region (181 in FIG. 20) and the number of information output cells configuring the information output regions (210-1 and 210-2 in FIG. 24) included in the information output device 200 are identical. That is, the coordinate information of the grid cells and the coordinate information of the information output cells may be identical.

However, it is not necessary that the coordinate information of the grid cells and the coordinate information of the information output cells are identical, and the coordinate information of the grid cells and the coordinate information of the information output cells may be different. If the coordinate information of the grid cells and the coordinate information of the information output cells are different, the coordinate information of the grid cells and the coordinate information of the information output cells that matches the coordinate information of the grid cell may be stored in the memory 130 in the tabulated form.

The processor 140 may detect the coordinate information of the information output cell that matches the coordinate information of the grid cell that displays meaningful information. The processor 140 may also detect the coordinate information of the information output cell that matches the coordinate information of the grid cell that displays non-meaningful information. Here, the coordinate information of the information output cell that matches the coordinate information of the grid cell that displays the meaningful information is assumed to be the first coordinate information of the information output cell, and the coordinate information of the information output cell that matches the coordinate information of the grid cell that displays the meaningful information is assumed to be the second coordinate information of the information output cell.

The processor 140 may generate a drive signal for an information output section corresponding to the coordinate information of an information output cell and transmit the drive signal to the information output device 200. The processor 140 may generate an upward drive signal for an information output section corresponding to the first coordinate information of an information output cell and a downward drive signal for an information output section corresponding to the second coordinate information of an information output cell. The processor 140 may transmit the upward drive signal or the downward drive signal, together with the first coordinate information or the second coordinate information corresponding to the upward or downward drive signal, respectively, to the information output device 200.

In an embodiment, the processor 140 may receive a touch of a grid cell display menu (182a in FIG. 20) embodied in a second region (182 in FIG. 20) at a location different from the first region that configures the user interface screen before outputting interactive information in the first region. The processor 140 may display a plurality of grid cells in the first region in response to the reception of a first touch signal for the grid cell display menu, and may terminate the display of the plurality of grid cells from the first region in response to the reception of a second touch signal for the grid cell display menu.

In an embodiment, the processor 140 may activate a page description window (183b in FIG. 20) in response to the reception of a touch signal for the page description window embodied in a third region (183 in FIG. 20) at a location different from the first region configuring the user interface screen. The processor 140 may receive input of descriptive text for the interactive information output in the first region from the page description window. In response to the reception of a touch signal for a Braille conversion menu (183c in FIG. 20) embodied at a location different from the page description window in the third region, the processor 140 may determine the completion of reception of the descriptive text and may convert the descriptive text into Braille. The processor 140 may display the result of descriptive text converted into Braille on a Braille output window (183d in FIG. 20) embodied at a location different from the Braille conversion menu in the third region. The processor 140 may transmit the Braille converted result displayed on the Braille output window to the information output device 200.

In this embodiment, the processor 140 may generate and transmit a drive signal for an information output section to the information output device 200 to cause the Braille converted result to be output in a second information output region (210-2 in FIG. 25) of the information output device 200. In another embodiment, the processor 140 may generate and transmit a drive signal for an information output section to cause graphical information to be output in a first information output region (210-1 in FIG. 25) and the Braille converted result to be output in the second information output region (210-2 in FIG. 25) of the information output device 200. In a still another embodiment, the processor 140 may generate and transmit to the information output device 200 a drive signal for the information output section to cause the output of the graphic information from the first information output region to be terminated, and the Braille converted result to be output when a preset time (e.g., 10 seconds) has elapsed after the graphic information is output in the first information output region.

FIGS. 19 to 21 are illustrations of a user interface screen displayed on the interactive information processing device of FIG. 18. In the following description, portions of the description that are redundant with the description with respect to FIGS. 17 and 18 will be omitted. Referring to FIGS. 19 to 23, the processor 140 may perform generation and control of response information in response to a user's touch on the user interface screen.

The user interface screen 150 illustrated in FIGS. 19 to 21 may include a first user interface region 160, a second user interface region 170, and a third user interface region 180.

The first user interface region 160 may include first (1-1) to third (1-3) UI menus 160a to 160c. Upon receiving a touch signal for the first UI menu 160a, the processor 140 may move the currently displayed user interface screen on the display part 120 to a canvas page. Upon receiving a touch signal for the second UI menu 160b, the processor 140 may move the currently displayed user interface screen on the display part 120 to a drive page. Upon receiving a touch signal for the third UI menu 160c, the processor 140 may change the language of the currently displayed user interface screen on the display part 120 to English or Korean. The second user interface region 170 may include first (2-1) to seventh (2-7) UI

menus 170a to 170g. Upon receiving a touch signal for the first UI menu 170a, New, the processor 140 may generate a new document tracking management system (DTMS) document. Here, the DTMS may include file extensions of document files generated by the interactive information processing device (100). Upon receiving a touch signal for the second UI menu 170b, Open, the processor 140 may open an existing DTMS document. Upon receiving a touch signal for the third UI menu 170c, Import, the processor 140 may insert a DTMS document. Upon receiving a touch signal for the fourth UI menu 170d, Export, the processor 140 may save the DTMS file to a specified local location, for example, to a specified location on a device (not shown) on which the interactive information processing device 100 is implemented, or to a specified location on an external device connected to the interactive information processing device 100. Upon receiving a touch signal for the fifth UI menu 170e, Save, the processor 140 may save the DTMS document. Upon receiving a touch signal for the sixth UI menu 170f, Setting, the processor 140 may generate a translation engine language. Upon receiving a touch signal for the seventh UI menu 170g, File Name, the processor 140 may enable file name input.

The third user interface region 180 may include a first sub-region 181, a second sub-region 182, and a third sub-region 183. The first sub-region 181 may display the interactive information described above. The processor 140 may cause the graphical information and/or textual information to be output by touch on the first sub-region 181. The processor 140 may cause the graphical information and/or textual information included in the file to be output by opening a file on the first sub-region 181.

Referring to FIG. 20, a plurality of grid cells may be displayed on the first sub-region 181 and the display of the plurality of grid cells may be terminated in response to a touch for a grid cell display menu 182a provided in the second sub-region 182. Upon receiving a first touch signal for the grid cell display menu 182a, the processor 140 may display the plurality of grid cells in the first sub-region 181 as illustrated in FIG. 20. Upon receiving a second touch signal for the grid cell display menu 182a, the processor 140 may terminate the display of the plurality of grid cells from the first sub-region 181, as illustrated in FIG. 21.

The second sub-region 182 may be provided with a plurality of menus 182a to 182v, and a touch for any of the menus may result in different interaction information being output in the first sub-region 181. Upon receiving a touch signal for the grid cell display menu 182a, the processor 140 may display the plurality of grid cells in the first sub-region 181 and/or terminate the display of the plurality of grid cells from the first sub-region 181.

Upon receiving a touch signal for the page panning menu 182b, the processor 140 may move files in thumbnail (page) units. Upon receiving a touch signal for the up arrow, the processor 140 may move a file upward. Upon receiving a touch signal for the down arrow, the processor 140 may move a file downward.

Upon receiving a touch signal for the add page menu 182c, the processor 140 may add a new page to the underlying page.

Upon receiving a touch signal for the Undo/Redo menu 182d, the processor 140 may undo the touch input of the first sub-region 181, or redo the touch input.

Upon receiving a touch signal for the thickness setting menu 182e, the processor 140 may vary the thickness of the information displayed by a touch on the first sub-region 181. When the leftmost thickness setting menu is touched, the thickness of the information displayed by a touch on the first sub-region 181 may be the thinnest, and when the rightmost thickness setting menu is touched, the thickness of the information displayed by a touch on the first sub-region 181 may be the thickest. The thinnest thickness may mean, for example, that the information is displayed up to ½ grid cell by a single touch on the first sub-region 181, without limitation. Also, the thickest thickness may mean, for example, that the information is displayed up to 3 grid cells by a single touch on the first sub-region 181, without limitation.

Upon receiving a touch signal for the pen menu 182f, the processor 140 may activate the pen and enable the display of the user input information on the first sub-region 181 in response to a click-and-drag operation.

Upon receiving a touch signal for the symmetrical drawing menu 182g, the processor 140 may activate the menu and enable mirroring display of the user input information on the first sub-region 181 in response to a click-and-drag operation.

Upon receiving a touch signal for the panning menu 182h, the processor 140 may activate the menu and enable the screen panning on the first sub-region 181 in response to a click-and-drag operation.

Upon receiving a touch signal for the fill menu 182i, the processor 140 may activate the menu and fill the clicked grid cell with a set color on the first sub-region 181 in response to a click operation.

Upon receiving a touch signal for the eraser menu 182j, the processor 140 may activate the menu and erase the displayed information on the first sub-region 181 in response to a click-and-drag operation.

Upon receiving a touch signal for the clear all menu 182k, the processor 140 may activate the menu and clear all displayed information on the first sub-region 181 in response to a click operation.

Upon receiving a touch signal for the line drawing menu 182l, the processor 140 may activate the menu and draw a line in the selected grid cell on the first sub-region 181 in response to a click-and-drag operation.

Upon receiving a touch signal for the rectangle menu 182m, the processor 140 may activate the menu and draw a rectangle in the selected grid cell on the first sub-region 181 in response to a click-and-drag operation.

Upon receiving a touch signal for the circle menu 182n, the processor 140 may activate the menu and draw a circle on the selected grid cell on the first sub-region 181 in response to a click-and-drag operation.

Upon receiving a touch signal for the triangle menu 182o, the processor 140 may activate the menu and draw a triangle on the selected grid cell on the first sub-region 181 in response to a click-and-drag operation.

Upon receiving a touch signal for the text input menu 182p, the processor 140 may activate the menu, pop up a text insertion window on the first sub-region 181, and in the event of the text input to the text insertion window, enable the text to be converted into Braille in real time and displayed.

Upon receiving a touch signal for the table drawing menu 182q, the processor 140 may activate the menu and draw a table on the first sub-region 181 in response to a click-and-drag operation.

Upon receiving a touch signal for the insert text menu 182r, the processor 140 may pop up a text file open window on the first sub-region 181 and enable the selected file to be converted into Braille in real time and displayed.

Upon receiving a touch signal for the insert image menu 182s, the processor 140 may pop up an insert image window on the first sub-region 181 and enable the selected image to be output in the first sub-region 181.

Upon receiving a touch signal for the rectangle selection menu 182t, the processor 140 may activate the menu and enable a rectangle to be selected on the first sub-region 181 in response to a click-and-drag operation.

Upon receiving a touch signal for the free selection menu 182u, the processor 140 may activate the menu and enable grid cells to be freely selected on the first sub-region 181 in response to a click-and-drag operation.

Upon receiving a touch signal for the color menu 182v, the processor 140 may display a color that is set upon left-clicking or right-clicking for the grid cells that displays the meaningful information output in the first sub-region 181.

Upon receiving a touch signal for the palette menu 182w, the processor 140 may set the touched color to be used.

The third sub-region 183 may be provided with a plurality of menus 183a to 183d. Upon receiving a touch signal for the print menu 183a, the processor 140 may transmit the interactive information printed on the first sub-region 181 to the information output device 200.

Upon receiving a touch signal for the page description menu 183b, the processor 140 may activate the page description window and enable descriptive text for the output interactive information to be input in the first sub-region 181.

Upon receiving a touch signal for the Braille conversion menu 183c, the processor 140 may convert the descriptive text input to the page description window into Braille, and display the Braille converted result in the page descriptive-Braille region 183d.

FIGS. 22 and 23 are illustrations of interactive information output in the third user interface region 180. In the following description, portions of the description that duplicate the description of FIGS. 17 to 21 will be omitted. Referring now to FIGS. 22 and 23, the processor 140 may generate and control response information in response to a user's touch on the third user interface region 180.

FIG. 22 illustrates interactive information output in the first sub-region 181 as the processor 140 moves a file in thumbnail (page) units in response to receiving a touch signal for the page panning menu 182b. In this embodiment, the interactive information may include Han-bok graphic information. On the first sub-region 181, the Han-bok may be represented by grid cells 181-1 displaying meaningful information and grid cells 181-2 displaying non-meaningful information.

FIG. 23 illustrates interactive information output in the first sub-region 181 as the processor 140 moves the file upward in response to receiving a touch signal for an up arrow of a page panning menu 182b. In this embodiment, the interactive information may include graphical information of a Korean flag. In this embodiment, the page description window shows a descriptive text for the interactive information output in the first sub-region 181, such as “This is the Korean flag.”, and the page descriptive-braille region 183d shows an example of the Braille converted result for the descriptive text.

FIGS. 24 to 26 are illustrations of information output devices included in an interactive information processing environment according to an embodiment of the invention. Referring to FIGS. 24 to 26, the information output device 200 may include a first information output region 210-1, a second information output region 210-2, and a plurality of user interfaces 220.

The first information output region 210-1 and the second information output region 210-2 may include a plurality of information output sections 240, which may output interactive information including at least one of graphical information and textual information in the form of Braille. In this embodiment, the size of the first information output region 210-1 may be larger than that of the second information output region 210-2.

In this embodiment, while the first information output region 210-1 may output graphical information and the second information output region 210-2 may output textual information, the inventive concepts are not limited to above, and one of graphical information and textual information may be output in either of the first information output region 210-1 and the second information output region 210-2.

The plurality of user interfaces 220 may include a controller to operate the information output device 200. The controller may include sensors, buttons, or switch structures that may recognize user's touch or press operations.

FIG. 26 is a diagram illustrating the operation of information output cells 230 included in the first information output region 210-1 and the second information output region 210-2 in FIG. 17. Referring to FIG. 26, the first information output region 210-1 and the second information output region 210-2 may include a plurality of information output cells 230. Braille information output in the first information output region 210-1 and the second information output region 210-2 may be output in the units of information output cells 230 including information output sections 240 arranged in four rows by two columns, and in this embodiment, the information output cells 230 may include eight information output sections 240. Although this embodiment specifies that the information output cell 230 includes eight information output sections 240, the inventive concepts are not limited thereto, and the information output cell 230 may include 2-8 information output sections 240, and in some cases, more than eight information output sections 240.

The information output section 240 according to the present embodiment may output information through an upward drive or a downward drive in response to receiving a drive signal for the information output section from the interactive information processing device 100.

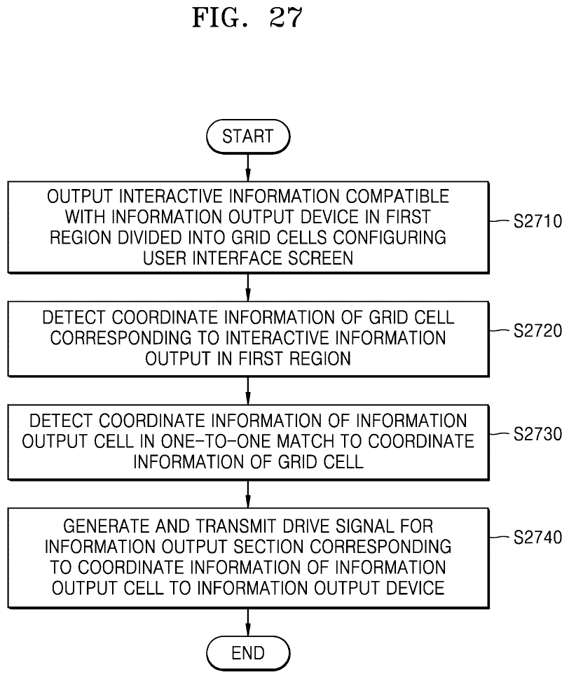

FIG. 27 is a flow diagram illustrating an interactive information processing method according to the present embodiment. In the following description, portions that are redundant with the description of FIGS. 17 to 26 will be omitted. The interactive information processing method according to the present embodiment will be described assuming that the interactive information processing device 100 performs operations in the processor 140 with assistance from peripheral components.

Referring to FIG. 27, in S2710, the processor 140 may output interactive information compatible with the information output device 200 in a first region divided into a plurality of grid cells configuring a user interface screen. In this embodiment, the interactive information may specifically include one or more files previously stored in memory, such as files previously created in the first region and stored in memory, and files captured in the first region and stored in memory. The interactive information may also include files received via communication with an external device (e.g., a server, a user terminal, etc.). Further, the interactive information may include a touch input generated by a real-time touch of the first region. Further, the interactive information may include a set of touch inputs generated by a touch of the first region until a touch signal for a print button embodied in a third region at a location different from the first region is received. Such interactive information may include one or more of graphical information and textual information.

In S2720, the processor 140 may detect coordinate information of a grid cell corresponding to the interactive information output in the first region.

In S2730, the processor 140 may detect coordinate information of an information output cell that is a one-to-one match to the coordinate information of the grid cell.

In S2740, the processor 140 may generate and transmit a drive signal for an information output section corresponding to the coordinate information of the information output cell to the information output device 200.

In this embodiment, the processor 140 may receive a touch of a grid cell display menu embodied in a second region at a location different from the first region that configures a user interface screen before outputting interactive information. The processor 140 may display a plurality of grid cells in the first region in response to the reception of a first touch signal for the grid cell display menu, and may terminate the display of the plurality of grid cells from the first region in response to the reception of a second touch signal for the grid cell display menu.

In this embodiment, the processor 140 may activate a page description window in response to the reception of a touch signal for the page description window embodied in a third region at a location different from the first region configuring the user interface screen before transmitting the drive signal to the information output device 200. The processor 140 may receive input of descriptive text for the interactive information output in the first region from the page description window. In response to the reception of a touch signal for a Braille conversion menu embodied in a second region, the processor 140 may determine the completion of reception of the descriptive text and may convert the descriptive text into Braille. The processor 140 may display the result of descriptive text converted into Braille on a Braille output window embodied in the third region. The processor 140 may transmit the Braille converted result displayed on the Braille output window to the information output device. The processor 140 may generate and transmit a drive signal for an information output section corresponding to the Braille converted result to the information output device 200.

In this embodiment, the processor 140 may receive specification information and drive information of the information output device from the information output device before transmitting the drive signal to the information output device 200. Here, the specification information and drive information associated with operation of the information output device 200 may include information about a first information output region and a second information output region configured at a different location than the first information output region. The processor 140 may generate drive signals for the information output section to output graphical information in the first information output region and to output textual information in the second information output region and transmit the drive signals to the information output device 200.

According to the inventive concepts, provided may be an information output apparatus and method, which enable particular information regarding various types of content to be easily recognized tactilely by controlling first and second information output portions that may tactilely sense according to the result of detecting an image and a text from input content to display the image on the first information output portion and display the text on the second information output portion.

According to the inventive concepts, a feature of a key subject within an image may be enabled to be intuitively recognized through tactile sensation by performing an image processing process (e.g., semantic rendering processing, binarized image generation) on the image detected from content and controlling a first information output portion on the basis of the result of performing the image processing process to display the feature of the key subject within the image on the first information output portion.

According to the inventive concepts, a first information output unit formed to tactilely sense in the event of upward movement or downward movement may be easily controlled to output a key subject within an image to a first information output portion by displaying a flag in at least one unit cell from among unit cells of a set size on the basis of the key subject within the image to generate a matching image for an output of the key subject and generate a driving signal for the first information output unit on the basis of the flag displayed in the matching image.

According to the inventive concepts, a key subject of an image may be accurately displayed even in the case where the image within content is distorted or partially unclear by detecting, from a memory, a reference key subject corresponding to the key subject of the image detected from the content and controlling a first information output portion on the basis of the reference key subject.

According to the inventive concepts, the interactive information processing device and method processes graphical information and transmits the processed graphical information to the tactile information output device so that the graphical information may be perceived through the tactile information output device.

The effects of the inventive concepts are not limited to that mentioned above, and other effects not mentioned will be clearly understood by those skilled in the art from the following description.

The above-mentioned embodiments of the inventive concepts may be embodied in the form of a computer program that may be executed by various components on a computer, and such a computer program may be recorded on a computer-readable medium. Here, the medium may include magnetic media such as hard disks, floppy disks, and magnetic tapes, optical recording media such as CD-ROMs and DVDs, magneto-optical media such as floptical disks, and hardware devices specifically configured to store and execute program instructions, such as ROM, RAM, flash memory, and the like.

The computer program may be specifically designed and configured for the present disclosure or may be known and available to those skilled in the art of computer software. Examples of computer programs may include machine language codes, such as those produced by a compiler, as well as high-level language codes that may be executed by a computer using an interpreter or the like.

In the description of the invention, as used here, the term “the” and similar indicative terms may refer to both the singular and plural. In addition, where a range is stated in the disclosure, it is intended to include the disclosure with individual values falling within the range (unless the contrary is stated), as if each individual value configuring the range were stated in the detailed description of the invention.

The steps of a method according to the invention may be performed in any order, unless an explicit order is stated or otherwise indicated. The invention is not necessarily limited to the order of the steps that is described. The use of any examples or exemplary terms (e.g., etc.) in the present disclosure is merely for the purpose of describing the inventive concepts in detail and is not intended to limit the scope of the invention by such examples or exemplary terms unless limited by the appended claims. Furthermore, those skilled in the art will recognize that various modifications, combinations, and changes may be made in accordance with design conditions and factors within the scope of the appended claims or equivalents thereof.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An apparatus for outputting information, the apparatus comprising:
a first information output portion comprising a first information output cell arranged in a grid structure and comprising a preset number of first information output units configured to tactilely sense in an event of upward movement or downward movement in at least one direction;
a second information output portion provided at a different location from the first information output portion and comprising a second information output cell arranged in a grid structure and comprisimg a preset number of second information output units; and
a processor configured to detect one or more of an image and a text from content being input, generate a first driving signal driving the first information output unit according to a result of detecting the image, transmit the first driving signal to the first information output portion, generate a second driving signal driving the second information output unit according to a result of detecting the text, and transmit the second driving signal to the second information output portion.

2. The apparatus of claim 1, wherein the processor is further configured to partition the image into one or more of a background and a key subject, generate a sub-image comprising the key subject and a feature of the key subject, process the sub-image to correspond to coordinate information of the first information output cell, and generate a driving signal for a first information output unit in response to the coordinate information, and transmit the driving signal to the first information output portion.

3. The apparatus of claim 2, wherein the processor is further configured to generate a binarized image for the sub-image by processing a portion indicating the feature of the key subject as a first value and a portion excluded from the feature as a second value, and process the binarized image to correspond to the coordinate information of the first information output cell.

4. The apparatus of claim 1, wherein the processor is further configured to generate, on the basis of the key subject detected in the image, a matching image for an output of the key subject by displaying a flag in at least one unit cell from among unit cells of a set size, generate a driving signal for the first information output unit on the basis of the flag displayed in the matching image, and transmit the driving signal to the first information output portion.

5. The apparatus of claim 4, further comprising a memory storing a reference key subject and a text naming the reference key subject, wherein the processor is further configured to detect, from the memory, any one reference key subject having a similarity of a reference value or more to the reference key subject, generate a matching image for an output of the reference key subject from the reference key subject, generate a driving signal for the first information output unit on the basis of the matching image, and transmit the driving signal to the first information output portion.

6. The apparatus of claim 4, further comprising a memory storing a reference key subject, a matching image for an output of the reference key subject, and a text naming the reference key subject, wherein the processor is further configured to detect, from the memory, the matching image for the output of the reference key subject having a similarity of a reference value or more to the key subject, generate a driving signal for the first information output unit on the basis of the matching image, and transmit the driving signal to the first information output portion.

7. The apparatus of claim ,5 wherein the processor is further configured to detect, from the memory, the text naming the reference key subject, convert the text into Braille characters, generate a driving signal for a second information output unit corresponding to the Braille characters, and transmit the driving signal to the second information output portion.

8. The apparatus of claim 1, wherein the processor is further configured to, in a case where a number of Braille characters converted from the text exceeds a maximum number of Braille characters output from the second information output portion and the image is capable of being output from the second information output portion, generate the first driving signal according to the result of detecting the text, transmit the first driving signal to the first information output portion, generate the second driving signal according to the result of detecting the image, and transmit the second driving signal to the second information output portion.

9. The apparatus of claim 1, wherein the processor is further configured to be linked to a request for additional information regarding the image to receive the additional information regarding the image from an external server, generate a second driving signal driving the second information output unit according to a result of detecting text from the additional information, and transmit the second driving signal to the second information output portion.

10. The apparatus of claim ,1 wherein the second information output portion comprises a horizontal information output portion provided in a horizontal direction with respect to the first information output portion and a vertical information output portion provided in a vertical direction with respect to the first information output portion, wherein the processor is further configured to select at least one information output portion from among the horizontal information output portion and the vertical information output portion on the basis of a preset priority, generate a driving signal driving an information output unit included in the selected information output portion according to the result of detecting the text, and transmit the driving signal to the selected information output portion.

11. A method of outputting information, performed by a processor of an apparatus for outputting information, the method comprising:
detecting one or more of an image and a text from content being input;
generating a first driving signal driving a first information output unit according to a result of detecting the image and transmitting the first driving signal to a first information output portion; and
generating a second driving signal driving a second information output unit according to a result of detecting the text and transmitting the second driving signal to a second information output portion, wherein the first information output portion comprises a first information output cell which is arranged in a grid structure and comprises a preset number of first information output units configured to tactilely sense in an event of upward movement or downward movement in at least one direction,
wherein the second information output portion is provided at a different location from the first information output portion and comprises a second information output cell arranged in a grid structure and comprising a preset number of second information output units.

12. The method of claim 11, wherein the generating the first driving signal and transmitting the first driving signal to the first information output portion comprises:
partitioning the image into one or more of a background and a key subject, and generating a sub-image comprising the key subject and a feature of the key subject;
processing the sub-image to correspond to coordinate information of the first information output cell; and
generating a driving signal for a first information output unit in response to the coordinate information and transmitting the driving signal to the first information output portion.

13. The method of claim 12, wherein the processing to correspond to the coordinate information of the first information output cell comprises:
generating a binarized image for the sub-image by processing a portion indicating the feature of the key subject as a first value and processing a portion excluded from the feature as a second value; and
processing the binarized image to correspond to the coordinate information of the first information output cell.

14. The method of claim 11, wherein the generating the first driving signal and transmitting the first driving signal to the first information output portion comprises:
on the basis of the key subject detected in the image, generating a matching image for an output of the key subject by displaying a flag in at least one unit cell from among unit cells of a set size; and
generating a driving signal for the first information output unit on the basis of the flag displayed in the matching image and transmitting the driving signal to the first information output portion.
